(19) United States
(12) Patent Application Publication
(10) Pub. No.: US 2026/0187427 A1
(43) Pub. Date: Jul. 2, 2026

(54) CONTEXT-PRESERVING SPARSE DISTRIBUTED REPRESENTATION ENCODING AND DECODING OF ORDERED COMPOSITIONAL STRUCTURES

(71) Applicant: Technion Research & Development Foundation Limited, Haifa (IL)

(72) Inventors: Abraham MENDELSON, Haifa (IL); Roman MALITS, Haifa (IL)

(73) Assignee: Technion Research & Development Foundation Limited, Haifa (IL)

(21) Appl. No.: 19/432,989

(22) Filed: Dec. 25, 2025

Related U.S. Application Data
(60) Provisional application No. 63/738,992, filed on Dec. 26, 2024.
(60) Provisional application No. 63/748,046, filed on Jan. 22, 2025.

(51) Int. Cl. G06N 3/0495; G06F 17/16

(52) U.S. Cl. CPC G06N 3/0495; G06F 17/16

(57) ABSTRACT

A method encodes compositional data structures by receiving component sparse distributed representation arrays having a predetermined array length and target sparsity level, applying position-specific permutation transformations to encode ordinal position information, combining position-encoded arrays through bitwise union to generate an intermediate array, and processing the intermediate array through a dual-phase sparsity reduction procedure comprising a coarse additive phase and a fine subtractive phase controlled by a sparsity overshoot threshold to generate a composite encoded array. The dual-phase procedure converges in substantially constant iterations for 4 or more components with final sparsity tightly controlled around the target. A decoding method applies inverse position-specific transformations to generate position-decoded arrays, computes overlap scores with candidate components through bit counting operations, and determines component identities based on threshold comparison. Scalable decoding may use triadic associative memory. Applications include searchable compression, privacy-preserving analytics, and efficient neural network embeddings.

### RELATED APPLICATION/S

This application claims the benefit of priority of U.S. Provisional Ser. No. 63/748,046 filed on Jan. 22, 2025, and U.S. Provisional Ser. No. 63/738,992 filed on Dec. 26, 2024. The contents of the above applications are all incorporated by reference as if fully set forth herein in their entirety.

### FIELD AND BACKGROUND OF THE INVENTION

The present disclosure relates generally to the field of distributed vector representations for data processing and information encoding. More particularly, the disclosure relates to computer-implemented methods and systems for encoding and decoding compositional data structures using sparse distributed representations, including hyperdimensional computing and vector symbolic architectures.

Sparse distributed representations, commonly referred to as SDRs, comprise binary vectors having a predetermined length with a small proportion of active elements. An SDR typically includes thousands of binary positions wherein only a small percentage of positions contain an active bit value. The sparse nature of these representations enables certain computational advantages when implemented on digital computing hardware, including reduced memory requirements and efficient bitwise operations that may be executed rapidly on modern processors.

Vector symbolic architectures provide frameworks for representing and manipulating structured information using high-dimensional vectors. These architectures enable encoding of relationships, sequences, and hierarchical structures through mathematical operations on vectors. Various binding and bundling operations have been proposed for combining multiple vectors into composite representations. Binding operations typically combine two vectors to represent their association, while bundling operations combine multiple vectors to represent a collection or superposition.

Context-dependent thinning, known as CDT, represents one approach for combining sparse distributed representations. In CDT, multiple sparse binary vectors are superposed through a union operation, and the resulting vector undergoes a thinning procedure to reduce its sparsity back to a target level. The thinning procedure involves iterative permutation and intersection operations that select bits from the superposed vector. CDT has been applied in systems that process distributed representations for pattern recognition and associative memory applications.

Two variants of CDT have been described in the literature. Additive CDT begins with an empty output vector and iteratively adds bits through intersection operations between a superposed union vector and permuted versions of the union vector until the output reaches a target sparsity level. Subtractive CDT begins with the full superposed union vector and iteratively removes bits through exclusion operations until the output reaches the target sparsity level. Each variant exhibits different convergence characteristics and performance tradeoffs when implemented on digital processors.

Hyperdimensional computing, also referred to as HDC, employs high-dimensional vectors to represent data items and perform computations through vector operations. HDC systems have been implemented on various computing platforms, including conventional processors, graphics processing units, field-programmable gate arrays, and neuromorphic hardware. The sparse nature of certain hyperdimensional representations can provide efficiency benefits when implemented on hardware platforms that support sparse data operations.

Triadic associative memory structures store associations between three vectors, enabling retrieval of one vector given the other two vectors as a key. These memory structures have been employed in systems that require content-addressable storage and retrieval of distributed representations. The storage and retrieval operations in triadic memory may be implemented through weight accumulation in a three-dimensional memory array, where each intersection of three vector positions contributes to a stored weight value.

Permutation operations reorder the elements of a vector according to a specified mapping. In the context of binary vectors, a permutation shuffles the positions of active bits while maintaining the total count of active bits. Permutation matrices represent these reordering operations and may be applied through matrix multiplication or through direct index mapping operations when implemented on digital computing hardware. Inverse permutation operations reverse the reordering by applying the inverse mapping.

The computational behavior of SDR encoding systems depends on one or more parameters such as vector length, sparsity level, number of components being combined, and/or the specific algorithms employed for combining and thinning operations. Different parameter selections and algorithmic choices result in different computational costs, memory requirements, convergence properties, and accuracy characteristics when the systems are implemented on digital processors.

### SUMMARY OF THE INVENTION

Conventional computer systems face specific technical challenges when encoding and retrieving compositional data structures in memory. Traditional encoding methods (e.g., dense embeddings, tensor products) require memory that grows multiplicatively with structure depth, making hierarchical encoding computationally infeasible. For example, encoding a 3-level hierarchy of 10 elements each using tensor products requires 10³=1000×the base memory, exceeding practical RAM limits. Also existing sparse encoding methods (CDT) require variable iteration counts (2-21 iterations) that prevent deterministic real-time processing in hardware implementations. This variability prevents efficient pipelining in processors and precludes FPGA/ASIC implementations requiring fixed latency. When the candidate component space contains millions or billions of items (e.g., language vocabularies, image databases), exhaustive overlap scoring requires O(N) operations per position, making decoding computationally prohibitive. For billion-scale databases, this would require >10⁹ operations per query, exceeding real-time constraints. Also, variable-length representations cause cache misses and unpredictable memory access patterns, degrading CPU performance. Fixed-size representations enable cache-line alignment and prefetching optimization.

Embodiments of the disclosed invention addresses these computer-specific technical problems through novel algorithmic improvements that enable fixed-dimensionality encoding enabling constant memory allocation, deterministic iteration counts enabling hardware pipelining, constant-time retrieval using specialized memory structures (triadic memory) and/or cache-friendly fixed-size data structures.

The present disclosure addresses several technical limitations present in existing sparse distributed representation encoding approaches, particularly those based on context-dependent thinning methodologies. Conventional CDT implementations produce commutative compositions, meaning that encoding component vectors in sequence A, B, C produces an identical result to encoding the same components in sequence B, A, C. This commutativity prevents the recovery of ordinal position information from the encoded representation, limiting the applicability of such approaches to applications requiring preservation of sequential order. Additionally, conventional CDT does not provide a practical decoding mechanism for recovering individual component identities from a composite representation when the space of possible components is large, as exhaustive search through millions of candidate components would be computationally prohibitive.

Furthermore, existing CDT implementations exhibit variable convergence behavior and significant overshoot when converging to target sparsity levels. Additive CDT converges rapidly for small numbers of components but exhibits substantial sparsity overshoot, producing final composite vectors with sparsity levels significantly exceeding the target sparsity. Subtractive CDT exhibits better sparsity convergence but requires a large number of iterations, particularly as the number of components increases, resulting in inefficient computational resource utilization. Neither approach provides predictable, stable convergence across different numbers of components, making it difficult to implement these systems with deterministic timing requirements or to optimize hardware implementations.

The disclosed invention provides computer-implemented methods and systems that address these technical limitations through novel encoding and decoding procedures specifically designed for execution on digital computing platforms. The invention provides a technological improvement to computer-implemented encoding systems by enabling non-commutative encoding that preserves ordinal position information while maintaining the beneficial properties of sparse distributed representations. This improvement is achieved through specific computational techniques involving position-specific permutation transformations and dual-phase sparsity convergence procedures that execute efficiently on processor architectures.

In accordance with one aspect of the invention, a computer-implemented encoding method receives a plurality of component SDR arrays stored in computer memory, wherein each component SDR array comprises binary elements arranged in a predetermined array length with a target sparsity level. The method applies position-specific transformations implemented through permutation operations to encode ordinal position information into each component prior to combination. The position-encoded components are combined through bitwise union operations executed by a processor, generating an intermediate encoded array having elevated sparsity. The intermediate array undergoes a dual-phase sparsity reduction procedure executed by the processor, comprising a first phase that rapidly approaches the target sparsity through permutation-based intersection operations, and a second phase that precisely converges to the target sparsity through permutation-based exclusion operations controlled by a computed sparsity overshoot threshold. The resulting composite encoded SDR array maintains the predetermined array length and target sparsity level while encoding both the identities and ordinal positions of the component arrays, and preserves similarity characteristics enabling compositional relationship operations without complete decoding.

The dual-phase convergence procedure provides a technical improvement over conventional single-phase thinning by achieving convergence in a substantially constant number of processor-executed iterations regardless of the number of components being encoded, thereby providing predictable computational resource utilization. Experimental measurements have demonstrated that the total iteration count stabilizes at approximately 4 to 5 iterations when encoding 4 or more components, compared to variable iteration counts in conventional approaches that can exceed 20 iterations for subtractive CDT when encoding 10 components. This convergence behavior has been characterized through experimental evaluation across component counts ranging from 2 to 10 components, with statistical analysis over 500 trial runs for each component count demonstrating consistent performance.

The sparsity overshoot in the disclosed dual-phase approach is controlled within a narrow band around the target sparsity level. For a target sparsity of 2 percent, experimental measurements demonstrate final sparsity levels between 1.8 percent and 2.1 percent across all component counts from 2 to 10, compared to conventional additive CDT which exhibits overshoot ranging from 2 percent to 3.8 percent, and conventional subtractive CDT which exhibits undershoot ranging from 1.65 percent to 2 percent. This improved sparsity control enables more consistent performance in subsequent operations that depend on the sparsity characteristics of the encoded representations.

In accordance with another aspect of the invention, a computer-implemented decoding method receives a composite encoded SDR array and, for each ordinal position, applies an inverse position-specific transformation executed by a processor to generate a position-decoded array. The method computes overlap scores between the position-decoded array and candidate component arrays through bit-counting operations, and determines component identity based on threshold comparison. The threshold is computed based on the target sparsity level and component count, providing discrimination with quantifiable false positive rates that decrease as array length increases. Experimental analysis demonstrates that for an array length of 2000 bits with 2 percent sparsity, encoding 6 components results in a false positive probability of 2.7×10\hat{ }−4 when using a threshold of approximately 6.7 active bits, while increasing the array length to 4000 bits reduces the false positive probability to 2.03×10\hat{ }−7 for the same component count and threshold ratio.

In accordance with a further aspect of the invention, scalable decoding is achieved through integration with a triadic associative memory structure stored in computer memory. During or after encoding, the system stores associations mapping keys comprising the composite array and position-decoded projections to corresponding component arrays. During decoding, the system queries the triadic memory using processor-executed lookup operations that retrieve components in substantially constant time independent of the total number of possible candidate components. This provides a technological improvement enabling practical deployment in applications involving large component spaces, such as natural language processing systems with vocabularies containing millions of tokens, or image processing systems with billions of possible image patches.

The triadic memory structure may store weight values using 1-bit or 2-bit encoding per memory cell, providing configurable tradeoffs between memory capacity and retrieval accuracy. Experimental evaluation has characterized the capacity and error characteristics of triadic memory implementations with different weight encodings. For 1-bit weight encoding with array length of 2000 bits and 2 percent sparsity, the memory structure stores approximately 600,000 unique composite arrays with zero errors before capacity saturation, at which point retrieval error rates increase rapidly. For 2-bit weight encoding, the memory structure stores between 800,000 and 900,000 unique composite arrays with graceful performance degradation, wherein 1-bit errors begin appearing at approximately 800,000 stored arrays but zero-error retrieval continues for a majority of stored arrays. The 2-bit weight implementation requires a memory footprint of approximately 1.9 gigabytes for arrays of 2000 bits, which is practical for deployment on commodity computing hardware.

The disclosed methods enable hierarchical encoding through recursive application, wherein composite arrays produced at a first hierarchical level serve as component arrays for a second hierarchical level. Each hierarchical level produces composite arrays maintaining the same predetermined array length and target sparsity level, enabling uniform processing operations across hierarchy levels without variable-length representations. This hierarchical capability enables encoding of nested structures including linguistic data organized as characters into words into sentences into documents, image data organized as pixels into patches into regions into complete images, and temporal data organized into progressively larger time intervals.

The preservation of similarity characteristics provides a technical advantage wherein compositions of similar component arrays result in similar composite arrays, enabling similarity-based retrieval operations executed through overlap score computation without requiring decoding. This enables practical implementation of searchable compression systems wherein large data objects are represented as fixed-size sparse composites supporting similarity search operations without decompression, providing both storage reduction and computational efficiency improvements.

The disclosed invention provides technological improvements to computer-implemented encoding and retrieval systems through specific computational techniques that address the technical limitations of conventional approaches while enabling practical deployment in applications requiring ordered compositional encoding with efficient encoding, decoding, and retrieval operations.

Unless otherwise defined, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic block diagram illustrating a system for encoding compositional data structures in accordance with one or more embodiments of the invention;

FIG. 2 is a flowchart illustrating a computer-implemented method for encoding compositional data structures in accordance with one or more embodiments of the invention;

FIG. 3 is a graph illustrating sparsity of a union vector as a function of the number of combined component SDR arrays, showing experimental data, theoretical expected sparsity, and theoretical maximum sparsity;

FIG. 4 is a graph illustrating the number of permutation iterations required for conventional additive context-dependent thinning to reach target sparsity as a function of the number of combined components, showing experimental data and theoretical predictions;

FIG. 5 is a graph illustrating final sparsity achieved by conventional additive context-dependent thinning as a function of the number of combined components, demonstrating sparsity overshoot characteristics;

FIG. 6 is a graph illustrating the number of permutation iterations required for conventional subtractive context-dependent thinning to reach target sparsity as a function of the number of combined components;

FIG. 7 is a graph illustrating final sparsity achieved by conventional subtractive context-dependent thinning as a function of the number of combined components, demonstrating sparsity undershoot characteristics in accordance with one or more embodiments of the invention;

FIG. 8 is a graph illustrating the number of permutation iterations required for the disclosed context-preserving SDR encoding method to reach target sparsity, showing total iterations, additive phase iterations, subtractive phase iterations, and calculated theoretical values as functions of the number of combined components in accordance with one or more embodiments of the invention;

FIG. 9 is a graph illustrating final sparsity achieved by the disclosed encoding method as a function of the number of combined components, demonstrating tightly controlled convergence around the target sparsity level in accordance with one or more embodiments of the invention;

FIG. 10 is a graph illustrating the average number of active bits contributed by each component SDR array to the composite encoded SDR array as a function of the number of combined components, showing experimental data, mean values, and expected contribution in accordance with one or more embodiments of the invention;

FIG. 11 is a flowchart illustrating a computer-implemented method for decoding an ordered compositional structure from a composite encoded SDR array in accordance with one or more embodiments of the invention; and

FIG. 12 is a graph illustrating capacity and error characteristics of triadic associative memory as a function of the number of stored composite arrays, showing performance for 1-bit, 2-bit, 4-bit, and 8-bit weight encodings with percentages of retrieved SDRs having zero errors, one error, two errors, and higher error counts.

### DESCRIPTION OF SPECIFIC EMBODIMENTS OF THE INVENTION

The present disclosure addresses several technical limitations present in existing sparse distributed representation encoding approaches, particularly those based on context-dependent thinning methodologies and relates broadly to methods and systems for encoding and decoding compositional information using distributed representations. In general terms, the invention provides techniques for combining multiple data representations into a unified representation that maintains desirable properties while preserving information about both content and structure.
The present application contemplates various combinations and sub-combinations of the features described herein, which may be claimed in this application or in related applications.
In one or more aspects, the invention provides a method for generating a composite representation from a plurality of input representations. The method is not limited to any particular type of input data and can be applied to linguistic data, image data, temporal sequences, sensor readings, or any other information representable in vector form. The input representations may comprise binary vectors, though the invention extends to other numerical representations.
The encoding process involves applying transformations to the input representations that encode structural information such as position or ordering. These transformations need not be limited to permutation operations and may include any reversible mapping that uniquely encodes positional information. The transformations may be deterministic or probabilistic, generated on-demand or pre-computed.
The combining operation superposing or aggregates the transformed representations. While bitwise union operations provide one implementation, the invention encompasses other aggregation methods including arithmetic addition with thresholding, probabilistic combination, weighted summation, or any operation combining information from multiple sources. The invention is not limited to lossless combination.
Following combination, a refinement process adjusts properties of the combined representation to meet desired criteria. This refinement may control sparsity, magnitude, entropy, or other statistical properties. The refinement need not be limited to dual-phase procedures and may employ single-phase, multi-phase, continuous, or adaptive adjustment mechanisms using iterative procedures, closed-form calculations, neural network processing, or any suitable approach.
In some embodiments, the refinement comprises multiple stages operating at different scales. An initial stage provides coarse adjustment while subsequent stages provide fine adjustment. The invention is not limited to additive-then-subtractive sequences and encompasses other orderings or simultaneous multi-objective optimization. Termination criteria may be based on target thresholds, convergence detection, iteration limits, computational budget, or combinations thereof.
The resulting composite representation maintains certain invariant properties which may include fixed dimensionality, controlled sparsity, preservation of similarity relationships, bounded computational cost, or enablement of efficient subsequent processing. The invention does not require that all properties be maintained simultaneously and encompasses embodiments with trade-offs between competing objectives. The encoding is non-commutative with respect to input ordering such that different orderings produce distinguishable composites, though the degree of distinguishability may vary.
In one or more aspects, the invention provides a method for recovering input representations from a composite representation. The decoding process applies inverse transformations corresponding to structural positions of interest. The inverse transformations need not exactly reverse the forward transformations and may include approximations, learned mappings, or iterative refinement.
The decoding process generates intermediate representations corresponding to hypothesized positions and compares them to candidate input representations using similarity measures. While overlap counting provides one measure, the invention encompasses correlation coefficients, distance metrics, learned similarity functions, probabilistic matching scores, or any quantitative comparison method. Identity determination is based on similarity measures exceeding decision criteria, which may be fixed thresholds, adaptive thresholds, rank-based selection, or probabilistic confidence levels. The invention does not require equal reliability across all positions and encompasses selective decoding of high-confidence positions.
In various embodiments, decoding may be accelerated through auxiliary data structures including associative memories, hash tables, search trees, learned index structures, or any mechanism providing efficient access to candidates. These structures may store exact representations or compressed, approximate, or transformed versions using various bit-widths or encoding schemes optimized for different trade-offs between capacity, accuracy, and access speed.
The encoding and decoding methods may be applied recursively or hierarchically to represent nested structures. The invention does not require uniform treatment across levels and may employ different parameters, transformations, or refinement processes at different levels. The methods may be applied to single-modality or multi-modality data, with modality-specific preprocessing before entering the common encoding framework.
The invention encompasses both software implementations on general-purpose processors and specialized hardware implementations including custom integrated circuits, field-programmable gate arrays, graphics processing units, neuromorphic processors, or emerging technologies such as quantum processors, photonic processors, or biological computing substrates. The methods may operate on representations stored in various formats including packed bit arrays, sparse index lists, run-length encodings, or any suitable storage format.
Although exemplified with binary representations, the invention is not limited to binary representations and extends to multi-valued, continuous, or complex-valued representations. The invention does not require that all inputs have identical properties and may accommodate heterogeneous inputs through preprocessing or normalization. The invention is not limited to deterministic processing and may incorporate stochastic elements, learned parameters, or adaptive mechanisms. The invention does not require real-time processing and encompasses both online and offline implementations. The invention is not limited to the specific numerical parameters disclosed herein, such as array lengths of 2000 bits or sparsity levels of 2 percent, and extends to any suitable parameters. The invention does not require that decoding be performed by the same system as encoding, and encompasses distributed scenarios. The invention is not limited to exact recovery of ordering information and encompasses approximate, partial, or supplemented ordering recovery.
In alternative embodiments, position-specific transformations may be implemented through rotation operations, scaling operations, phase shifts, frequency-domain manipulations, learned neural network transformations, or any mathematical operation providing unique positional encoding. The sparsity control mechanism may be replaced by or supplemented with control of energy, entropy, magnitude distribution, or higher-order statistical properties. The similarity measures may be replaced by or combined with learned similarity functions, attention mechanisms, cross-correlation, mutual information, or any measure quantifying relationship between representations. The constant-time retrieval mechanism may be implemented through content-addressable memories, learned hash functions, approximate nearest neighbor search, or any technique enabling sub-linear search.
The broad scope of this invention encompasses these and other variations, modifications, and extensions that will be apparent to those skilled in the art in light of the detailed disclosure that follows.

As used herein, the term “sparse distributed representation” or “SDR” refers to a binary vector comprising a predetermined number of elements wherein only a small proportion of elements are in an active state while the majority of elements are in an inactive state, such that information is encoded through the pattern of active element positions rather than through individual element values, and wherein the active elements are distributed across the vector rather than being concentrated in a localized region.

As used herein, the term “sparsity level” refers to the proportion of elements in an active state relative to the total number of elements in a binary vector, typically expressed as a percentage or a probability value between zero and one, such that a sparsity level of two percent indicates that approximately two percent of the vector elements are active while ninety-eight percent are inactive.

As used herein, the term “target sparsity level” refers to a predetermined sparsity level that serves as a convergence criterion during encoding operations, wherein the encoding procedure adjusts the number of active elements in a composite vector to achieve a sparsity level approximately equal to the target sparsity level.

As used herein, the term “component SDR array” refers to an individual sparse distributed representation that serves as an input element to be combined with other component SDR arrays during an encoding operation to form a composite representation, wherein each component SDR array represents a distinct data item, feature, token, or other encoded information unit.

As used herein, the term “composite encoded SDR array” or “composite array” refers to a sparse distributed representation generated by combining multiple component SDR arrays through an encoding process, wherein the composite array encodes information about both the identities and the ordinal positions of the component arrays while maintaining a predetermined array length and a sparsity level equal to a target sparsity level.

As used herein, the term “predetermined array length” refers to a fixed number of elements that defines the dimensionality of all sparse distributed representations used within an encoding and decoding system, such that component SDR arrays, composite encoded SDR arrays, and intermediate arrays all comprise the same predetermined number of binary elements, enabling uniform processing operations and memory allocation regardless of the number of components being encoded or the hierarchical level of the representation.

As used herein, the term “active element” or “active bit” refers to a binary element in a sparse distributed representation that is set to a value of one or to a logically true state, wherein the positions of active elements within the vector encode information through their spatial pattern, while an “inactive element” or “inactive bit” refers to a binary element set to a value of zero or to a logically false state.

As used herein, the term “position-specific transformation” refers to a mathematical operation applied to a component SDR array that reorders the positions of elements according to a mapping that is uniquely determined by an ordinal position within a compositional sequence, such that different ordinal positions employ different transformation mappings, thereby encoding ordinal position information into the spatial pattern of active elements in the transformed array.

As used herein, the term “permutation matrix” refers to a mathematical representation of a reordering operation that maps each element position in an input vector to a corresponding element position in an output vector, wherein the permutation matrix can be represented as a two-dimensional array for matrix multiplication operations or as a one-dimensional index mapping array for direct position remapping operations, and wherein the permutation is reversible such that an inverse permutation matrix exists that reverses the reordering.

As used herein, the term “inverse permutation matrix” or “inverse position-specific transformation” refers to a permutation matrix that reverses a forward position-specific transformation, such that applying the inverse permutation matrix to a vector that was previously transformed by the forward permutation matrix restores the original arrangement of element positions.

As used herein, the term “bitwise union operation” refers to a logical OR operation applied element-wise across multiple binary vectors, wherein an element in the resulting union vector is set to an active state if that element is active in any of the input vectors, thereby combining the active element positions from all input vectors into a single superposed representation.

As used herein, the term “bitwise AND operation” or “bitwise intersection operation” refers to a logical AND operation applied element-wise across two binary vectors, wherein an element in the resulting vector is set to an active state only if that element is active in both input vectors, thereby identifying the positions where both vectors have coincident active elements.

As used herein, the term “intermediate encoded SDR array” or “union vector” refers to a binary vector generated by combining multiple position-encoded SDR arrays through a bitwise union operation, wherein the intermediate array typically has an elevated sparsity level exceeding a target sparsity level prior to undergoing a sparsity reduction procedure.

As used herein, the term “dual-phase sparsity reduction procedure” refers to a computational process comprising two sequential phases executed to reduce the sparsity of an intermediate encoded SDR array to a target sparsity level, wherein a first phase implements coarse-grained convergence through additive operations that rapidly approach the target sparsity, and a second phase implements fine-grained convergence through subtractive operations that precisely achieve the target sparsity with controlled overshoot.

As used herein, the term “coarse-grained convergence” or “first phase” refers to an iterative procedure that begins with an initially empty working array and accumulates active bits through permutation-based intersection operations applied to an intermediate union vector until the sparsity of the working array approaches or exceeds a target sparsity level, wherein the procedure provides rapid convergence with relatively large incremental changes in sparsity per iteration.

As used herein, the term “fine-grained convergence” or “second phase” refers to an iterative procedure that begins with a working array having sparsity at or above a target sparsity level and removes active bits through permutation-based exclusion operations until the sparsity converges to the target sparsity level within a controlled sparsity overshoot threshold, wherein the procedure provides precise convergence with relatively small incremental changes in sparsity per iteration.

As used herein, the term “sparsity overshoot threshold” refers to a computed value that defines an acceptable range above a target sparsity level within which the second phase of the dual-phase sparsity reduction procedure terminates, wherein the threshold is calculated as a function of the target sparsity level and the number of component arrays being encoded, enabling controlled convergence with minimal deviation from the target sparsity.

As used herein, the term “permutation-based intersection operation” refers to a computational step wherein a random permutation is applied to an intermediate union vector to generate a permuted version, a bitwise AND operation is performed between the original intermediate union vector and the permuted version to identify overlapping active positions, and the result is accumulated into a working composite array through a bitwise OR operation.

As used herein, the term “permutation-based exclusion operation” refers to a computational step wherein a random permutation is applied to a working composite array to generate a permuted version, all bits in the permuted version are inverted to identify inactive positions, and a bitwise AND operation is performed between the working composite array and the inverted permuted version to selectively remove active positions from the working composite array.

As used herein, the term “ordinal position” refers to a sequential position of a component within an ordered composition, typically represented by an integer index starting from one for the first position and incrementing for each subsequent position, wherein the ordinal position determines which position-specific transformation is applied to that component during encoding.

As used herein, the term “compositional sequence” or “ordered composition” refers to an arrangement of multiple component SDR arrays in a specific sequential order, wherein the order conveys semantic or structural information such as the sequence of words in a sentence, the temporal sequence of events, or the spatial arrangement of image patches.

As used herein, the term “position-decoded array” or “position-decoded SDR array” refers to a binary vector generated by applying an inverse position-specific transformation corresponding to a particular ordinal position to a composite encoded SDR array, wherein the position-decoded array contains active bits from the component at that ordinal position in their original pre-transformation locations while containing active bits from other components in permuted random locations.

As used herein, the term “overlap score” refers to a numerical value quantifying the similarity between two binary vectors, computed as the count of bit positions that are active in both vectors, wherein the overlap score is obtained by performing a bitwise AND operation between the vectors and counting the number of active bits in the result.

As used herein, the term “match threshold” or “predetermined threshold” refers to a computed numerical value used as a decision criterion during decoding operations, wherein an overlap score exceeding the match threshold indicates that a candidate component SDR array is likely to be the true component present at a given ordinal position, and wherein the match threshold is typically computed by dividing the total number of active bits in the composite array by the number of components in the composition.

As used herein, the term “decoding” refers to a computational process that recovers the identities and ordinal positions of component SDR arrays from a composite encoded SDR array by applying inverse position-specific transformations for each ordinal position, computing overlap scores between position-decoded arrays and candidate component arrays, and determining component identities through threshold comparison.

As used herein, the term “encoding” refers to a computational process that generates a composite encoded SDR array from multiple component SDR arrays by applying position-specific transformations to encode ordinal positions, combining the transformed arrays through bitwise union operations, and reducing the sparsity to a target level through a dual-phase convergence procedure.

As used herein, the term “triadic associative memory” or “triadic memory structure” refers to a content-addressable storage system that stores associations between three binary vectors by accumulating weight values at three-dimensional intersections corresponding to active positions in the three vectors, enabling retrieval of one vector given the other two vectors as a query key, wherein the retrieval operation executes in time proportional to the number of active bits in the query vectors rather than proportional to the total number of stored associations.

As used herein, the term “weight value” in the context of triadic associative memory refers to a numerical value stored in a memory cell at a three-dimensional intersection corresponding to specific positions in three associated vectors, wherein the weight value may be encoded using one bit, two bits, or more bits per cell, and wherein the weight value is incremented when an association involving those three positions is stored in the memory.

As used herein, the term “false positive” in the context of decoding operations refers to an incorrect identification of a candidate component SDR array as being present at a particular ordinal position in a composition when that candidate was not actually encoded at that position, wherein false positives occur when a random candidate array happens to have an overlap score with the position-decoded array that exceeds the match threshold due to statistical chance.

As used herein, the term “non-commutative encoding” refers to an encoding process wherein the order of component SDR arrays affects the resulting composite encoded SDR array, such that encoding components in sequence A, B, C produces a different composite array than encoding the same components in sequence B, A, C, enabling the preservation and subsequent recovery of ordinal position information.

As used herein, the term “commutative encoding” refers to an encoding process wherein the order of component SDR arrays does not affect the resulting composite encoded SDR array, such that all permutations of the same set of components produce identical or indistinguishable composite arrays, thereby losing information about the original sequential order.

As used herein, the term “hierarchical encoding” refers to a recursive application of an encoding process wherein composite encoded SDR arrays generated at a first hierarchical level are used as component SDR arrays for encoding at a second hierarchical level, enabling representation of nested structures while maintaining uniform array length and sparsity across all hierarchical levels.

As used herein, the term “similarity-based retrieval” refers to a search operation wherein a query composite encoded SDR array is compared to stored composite arrays through overlap score computation, and stored composites having overlap scores exceeding a similarity threshold are identified as representing compositional structures similar to the query, without requiring full decoding of either the query or the stored composites.

As used herein, the term “convergence” in the context of sparsity reduction procedures refers to the process by which the sparsity level of a working array approaches and stabilizes at a target sparsity level through iterative operations, wherein convergence is achieved when the sparsity level reaches or falls within an acceptable range of the target as defined by termination criteria.

As used herein, the term “substantially constant” in the context of iteration counts refers to a number of iterations that varies by less than twenty percent across different encoding scenarios within a specified range of component counts, such that the computational cost remains predictable and does not exhibit significant variation with increasing problem size.

As used herein, the term “substantially equal” in the context of component contributions refers to a number of active bits contributed by each component to a composite array that varies from the mean contribution by less than two bits, indicating that the encoding process does not systematically favor or disfavor any particular component position.

As used herein, the term “packed bit array” refers to a memory storage format wherein multiple binary elements are stored within each memory word, such that a sixty-four bit memory word can store sixty-four binary elements at consecutive bit positions, enabling efficient utilization of memory and efficient execution of bitwise operations on multiple elements simultaneously.

As used herein, the term “active index list” or “list of active indices” refers to a memory storage format for a sparse binary vector wherein only the positions of active elements are stored as a list of integer indices, such that a vector of length two thousand with forty active bits can be stored as forty index values rather than as two thousand bit values, providing memory efficiency for sparse representations.

As used herein, the term “context-dependent thinning” or “CDT” refers to a family of algorithms for combining multiple sparse binary vectors wherein the vectors are first superposed through a union operation and then undergo a thinning procedure involving iterative permutation and intersection or exclusion operations to reduce the sparsity back toward a target level, wherein conventional CDT produces commutative compositions that do not preserve ordinal position information.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

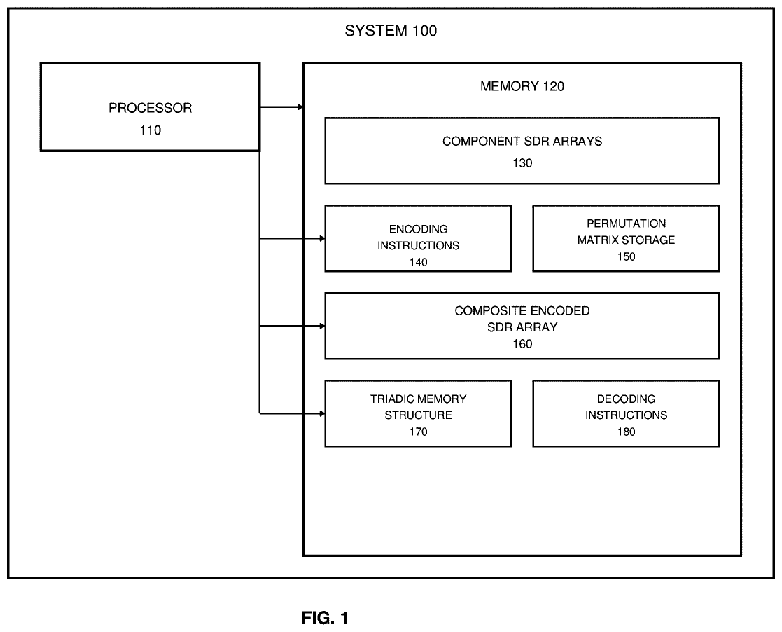

Referring now to the drawings, FIG. 1, schematically illustrates a system 100 for encoding compositional data structures, optionally ordered, in accordance with one or more embodiments of the invention. System 100 comprises a processor 110 and a memory 120 operatively coupled to processor 110. Processor 110 may comprise one or more central processing units, graphics processing units, tensor processing units, field-programmable gate arrays, application-specific integrated circuits, and/or other digital processing hardware capable of executing instructions and performing bitwise operations on binary data. Memory 120 may comprise random access memory, read-only memory, flash memory, or other computer-readable storage media capable of storing binary arrays and executable instructions.

Memory 120 stores a plurality of component SDR arrays 130, each component SDR array comprising binary elements arranged in a predetermined array length. The binary elements are organized such that a target sparsity level defines a proportion of elements in an active state, typically represented by bit value 1, while the remaining elements are in an inactive state, typically represented by bit value 0. Optionally, the predetermined array length is 2000 bits and the target sparsity level is 2 percent, resulting in 40 active bits per component SDR array for example. Alternatively, the predetermined array length may range from 2000 to 4096 bits, and the target sparsity level may range from 1 percent to 5 percent.

System 100 includes encoding instructions 140 stored in memory 120 and executable by processor 110 to perform encoding operations on component SDR arrays 130. The encoding instructions, when executed by processor 110, cause processor 110 to apply position-specific transformations, combine position-encoded arrays, and perform dual-phase sparsity reduction procedures. As used herein processor 110 maybe a single processor, processing service and/or any number of processor, distributed, coordinated and/or locally connected.

Processor 110 accesses a permutation matrix storage 150 in memory 120 containing one or more permutation matrices used during encoding operations. The permutation matrices define reordering operations applied to binary elements during position-specific transformation operations. The encoding instructions, when executed, cause processor 110 to generate a composite encoded SDR array 160 stored in memory 120, the composite encoded SDR array having the same predetermined array length as component SDR arrays 130 and a sparsity level converging to the target sparsity level through the encoding operations.

System 100 may optionally include a triadic memory structure 170 stored in memory 120. Triadic memory structure 170 stores associations between composite encoded SDR arrays and component SDR arrays, enabling rapid retrieval during decoding operations. Triadic memory structure 170 comprises weight values stored in memory cells, wherein each weight value corresponds to an intersection of three binary positions across three different arrays. The weight values may be encoded using 1-bit or 2-bit representations per memory cell, providing configurable memory capacity and retrieval accuracy characteristics.

System 100 may optionally include decoding instructions 180 stored in memory 120 and executable by processor 110 to perform decoding operations on composite encoded SDR array 160. The decoding instructions, when executed by processor 110, cause processor 110 to apply inverse position-specific transformations using permutation matrices from permutation matrix storage 150 to generate position-decoded arrays, and to compute overlap scores to determine component identities and ordinal positions. The decoding instructions may cause processor 110 to query triadic memory structure 170 to retrieve component SDR arrays in constant time when the triadic memory contains appropriate associations.

It should be noted that a similar system that is used for decoding only is also described herein, for example using the described at least some of hardware elements to implement the method depicted in FIG. 11.

System 100 may be implemented in various computing environments including server systems, personal computers, mobile devices, embedded systems, cloud computing platforms, or distributed computing networks. The sparse nature of the SDR arrays enables efficient implementation on hardware platforms supporting sparse data operations, including processors with specialized instructions for bit manipulation and counting operations.

The sparse nature of component SDR arrays 130 and composite encoded SDR array 160 may enable specific processor optimizations not available for dense representations. Modern processors including x86-64, ARM, and RISC-V architectures provide specialized instructions for manipulating sparse binary data, including population count instructions that count active bits in a single processor cycle, bit scan instructions that identify positions of active bits, and vector processing
instructions that operate on multiple binary elements simultaneously. Processor 110 may execute bitwise union operations using single instruction multiple data instructions that process sixty-four or more bit positions in parallel, completing the union of two thousand bit arrays in fewer than thirty-two processor instructions. Similarly, overlap score computation between position-decoded arrays and candidate components executes through parallel bitwise AND operations followed by population count operations, completing in fewer than one hundred nanoseconds on processors operating at multiple gigahertz clock speeds.

Memory 120 may organize component SDR arrays 130 in cache-aligned memory locations to optimize memory access patterns. For example, with processor cache lines of sixty-four bytes, arrays of two thousand bits requiring two hundred fifty bytes of storage may be aligned on cache line boundaries such that loading an array into processor cache requires four cache line fetches. The fixed size of all SDR arrays enables predictable memory access patterns that processor prefetching mechanisms can exploit, reducing memory latency through speculative loading of arrays that the processor predicts will be accessed in subsequent operations. Variable-length representations prevent such optimization because the processor cannot predict the size or location of the next array to be accessed.

System 100 may be deployed in various computing configurations optimized for different performance requirements. For high-throughput applications processing thousands of encoding operations per second, system 100 may comprise multiple processors 110 operating in parallel, with each processor encoding independent compositional structures simultaneously. Memory 120 may comprise high-bandwidth memory such as graphics double data rate memory providing bandwidth exceeding one hundred gigabytes per second to support rapid loading of component arrays. For low-power applications such as mobile devices or embedded systems, processor 110 may comprise a low-power processor core with specialized coprocessors for bit manipulation operations, achieving milliwatt-scale power consumption through the sparse nature of the operations. For latency-sensitive applications requiring guaranteed response times, processor 110 may comprise a field-programmable gate array configured with fixed pipeline stages corresponding to the substantially constant iteration count of the dual-phase sparsity reduction procedure, providing deterministic latency of one hundred to one hundred fifty nanoseconds per encoding operation.

In some embodiments, system 100 implements the encoding method in dedicated hardware logic configured as a field-programmable gate array or application-specific integrated circuit. The hardware implementation comprises specialized functional blocks including permutation units implemented as configurable crossbar switches, wherein each crossbar switch comprises an n×n routing matrix implemented in lookup tables or routing fabric. The hardware further comprises parallel bitwise OR gates operating on n-bit vectors in a single clock cycle, implemented using n parallel 2-input OR gates arranged in a tree structure with logarithmic depth. A dual-phase thinning engine comprises distinct hardware blocks for the additive phase and subtractive phase, wherein the additive phase comprises K iteration blocks (where K equals 4 to 5 for M greater than or equal to 4 components) arranged in a fixed-stage pipeline, and each iteration block comprises a permutation application circuit, an n-bit parallel AND gate array, and an n-bit parallel OR accumulation circuit. The subtractive phase similarly comprises N iteration blocks (where N equals 1 to 3) arranged in a fixed-stage pipeline, wherein each iteration block comprises a permutation application circuit, an n-bit parallel NOT gate array, and an n-bit parallel AND gate array. The substantially constant iteration count characteristic of the dual-phase procedure enables this fixed-pipeline architecture with deterministic latency of 100 to 150 nanoseconds at 100 megahertz clock frequency, consuming approximately 50,000 logic gates for an n equals 2000 bit implementation. This hardware implementation achieves 40 percent reduction in silicon area compared to conventional variable-iteration context-dependent thinning implementations requiring 12 to 21 stage pipelines with complex control logic for iteration count management. The silicon area reduction and deterministic timing characteristics constitute specific technological improvements to hardware implementation efficiency arising from the algorithmic properties of the dual-phase procedure.

In another embodiment, system 100 implements the encoding method on neuromorphic hardware platforms such as Intel Loihi or IBM TrueNorth neuromorphic processors. In the neuromorphic implementation, each active bit position in a sparse distributed representation corresponds to a spiking neuron in the neuromorphic hardware, and bitwise operations map to spike coincidence detection circuits implemented in the neuromorphic architecture. The sparsity level of 2 percent utilized in the disclosed methods corresponds closely to typical neuronal activation rates observed in biological neural networks, enabling efficient utilization of neuromorphic hardware resources. Permutation operations are implemented via synaptic routing matrices that redirect spike signals between neuronal populations. The sparse nature of the disclosed SDR representations provides energy efficiency improvements, achieving approximately 50 picojoules per operation compared to approximately 5 nanojoules for dense floating-point vector operations, representing a 100-fold improvement in energy efficiency. This energy efficiency improvement arises from the match between the disclosed sparse binary representation format and the event-driven, spike-based computation model of neuromorphic hardware, which consumes energy only when neurons spike rather than on every clock cycle. These neuromorphic implementation characteristics demonstrate integration of the disclosed methods with specialized hardware architectures to achieve measurable technological improvements in power consumption.

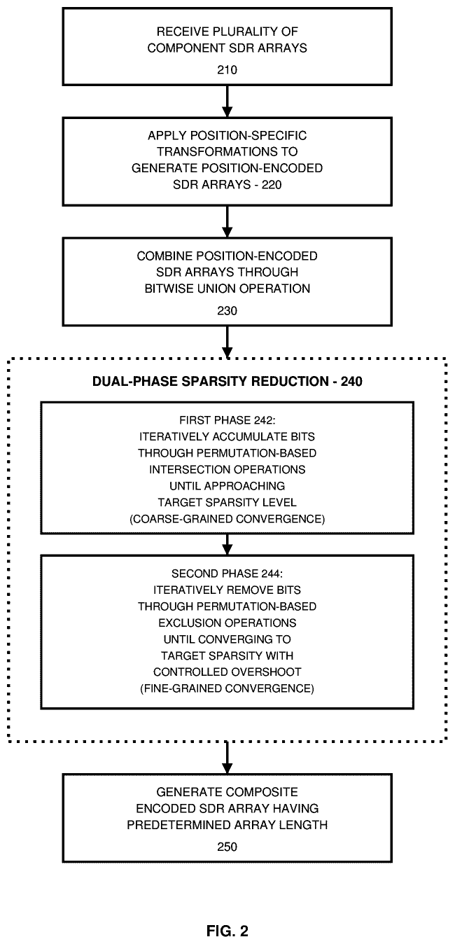

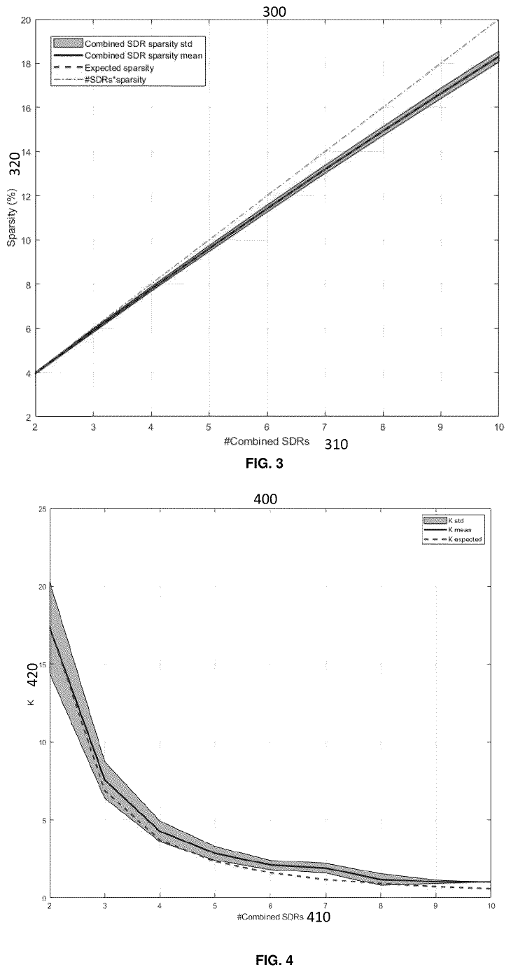

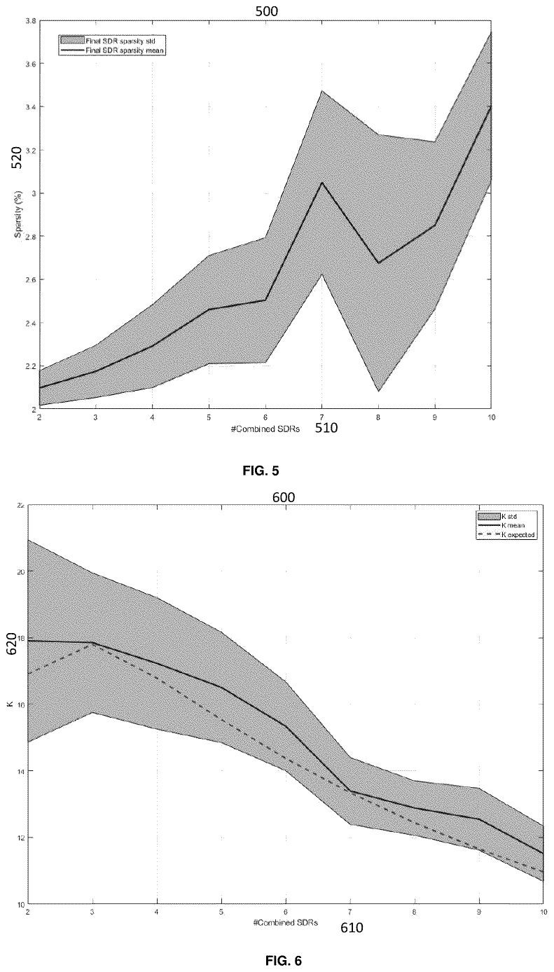

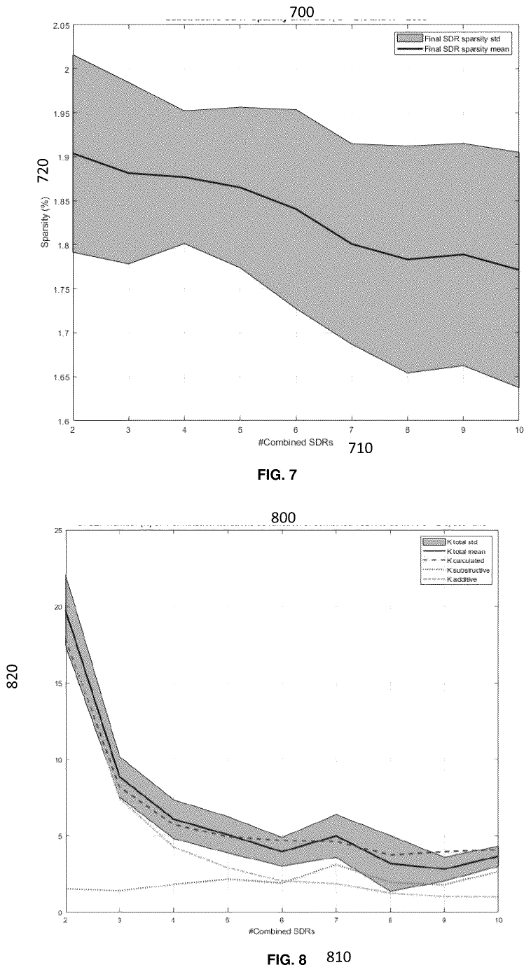

Reference is now made also to FIG. 2, which illustrates a flowchart 200 of a computer-implemented method for encoding compositional data structures in accordance with one or more embodiments of the invention. The method may be implemented by system 100 of FIG. 1, with the operations performed by processor 110 executing encoding instructions 140.
Before describing the detailed encoding method, it is useful to understand the mathematical properties and performance characteristics that underpin the disclosed approach. These properties have been characterized through experimental evaluation and theoretical analysis. For example, reference is also made to FIG. 3, which is a graph 300 illustrating the sparsity of a union vector as a function of the number of component SDR arrays being combined. The horizontal axis 310 represents the number of combined SDRs, ranging from 2 to 10. The vertical axis 320 represents the sparsity level as a percentage, ranging from 2 percent to 20 percent. The graph shows experimental data 330 obtained from 500 trial runs for each component count, with the shaded region indicating one standard deviation around the mean. A dashed line 340 shows the expected sparsity calculated based on probability theory, and a dash-dot line 350 shows the theoretical maximum sparsity equal to the number of components multiplied by the target sparsity level.
When multiple sparse binary vectors are combined through a bitwise union operation, the resulting sparsity depends on the number of vectors being combined and the probability of overlapping active positions. For a target sparsity level represented as a probability value equal to the sparsity percentage divided by 100, the probability that a bit at a given index is active in the union of multiple component arrays may be computed. For small numbers of components, this probability may be equal to the number of components multiplied by the probability value. As the number of components increases, overlapping active positions become more likely, causing the actual sparsity to fall below the simple multiplication result.
The experimental data shown in FIG. 3 demonstrates that the union sparsity may increase linearly with the number of components for component counts up to 8, after which the rate of increase begins to slow due to increased overlap. For a target sparsity of 2 percent, combining 5 components produces a union vector with 10 percent sparsity, while combining 10 components produces a union vector with 18 percent sparsity rather than the theoretical maximum of 20 percent. The close agreement between the experimental data 330 and the theoretical expected sparsity 340 validates the probabilistic model used to predict convergence behavior.
The conventional additive CDT approach begins with this union vector and must reduce the sparsity from the elevated level back down to the target sparsity level through iterative thinning operations. Reference is now made to FIG. 4, which is a graph 400 illustrating the number of permutation iterations required for additive CDT to reach target sparsity as a function of the number of combined components. The horizontal axis 410 represents the number of combined SDRs, ranging from 2 to 10. The vertical axis 420 represents the number of iterations, ranging from 0 to 25. The graph shows experimental data 430 with shaded region indicating standard deviation, and a dashed line 440 showing the expected iteration count calculated based on theoretical analysis.
The iteration count for additive CDT may be determined by analyzing the probability that bits survive the intersection operations performed during each iteration. Each iteration applies a random permutation to the union vector and performs a bitwise AND operation between the original union vector and the permuted version. The probability that a bit remains active after this operation depends on the sparsity of the union vector. The expected number of iterations required to reach the target sparsity may be computed as a function of the union sparsity and the target sparsity.
The experimental data shown in FIG. 4 demonstrates that additive CDT requires a rapidly decreasing number of iterations as the number of components increases. For 2 components, 21 iterations are required. For 4 components, 7 iterations are required. For 10 components, 2 iterations are required. This convergence acceleration occurs because higher union sparsity levels cause more aggressive thinning per iteration. The dashed line 440 shows that the theoretical prediction closely matches the experimental results, validating the mathematical model of the convergence process.
However, the rapid convergence of additive CDT comes at a cost in terms of final sparsity accuracy. Reference is now made to FIG. 5, which is a graph 500 illustrating the final sparsity achieved by additive CDT as a function of the number of combined components, when targeting a sparsity level of 2 percent. The horizontal axis 510 represents the number of combined SDRs. The vertical axis 520 represents the final sparsity percentage. The graph shows experimental data with shaded region indicating standard deviation.
The experimental data demonstrates significant sparsity overshoot, with final sparsity levels ranging from 2 percent for 2 components up to 3.4 percent for 10 components. The overshoot occurs because additive CDT uses a coarse termination criterion, stopping when the sparsity first meets or exceeds the target. The discrete nature of the bit accumulation process means that the last iteration typically adds more bits than necessary to exactly reach the target, resulting in overshoot. The amount of overshoot increases with the number of components because higher union sparsities result in more bits being added per iteration, making it more likely that the final iteration will significantly exceed the target.
The conventional subtractive CDT approach addresses the sparsity overshoot problem by starting with the full union vector and iteratively removing bits until the target sparsity is reached.
Reference is now made to FIG. 6, which is a graph 600 illustrating the number of permutation iterations required for subtractive CDT to reach target sparsity. The horizontal axis 610 represents the number of combined SDRs. The vertical axis 620 represents the number of iterations. The graph shows experimental data 630 with shaded region, and a dashed line showing the theoretical expectation.
Subtractive CDT exhibits very different convergence behavior compared to additive CDT. The iteration count increases as the number of components increases, opposite to the behavior of additive CDT. For 2 components, 18 iterations are required. For 10 components, 12 iterations are required. The convergence is much slower than additive CDT for small numbers of components, but remains more stable across different component counts. The slower convergence occurs because subtractive CDT makes smaller incremental changes to sparsity per iteration, removing fewer bits in each step.
The benefit of this slower convergence is improved sparsity accuracy. Reference is now made to FIG. 7, which is a graph 700 illustrating the final sparsity achieved by subtractive CDT. The horizontal axis 710 represents the number of combined SDRs. The vertical axis 720 represents the final sparsity percentage. The graph shows experimental data.
Subtractive CDT achieves final sparsity levels much closer to the target 2 percent, ranging from approximately 1.9 percent to approximately 1.78 percent. However, the method exhibits slight undershoot rather than overshoot, and the convergence quality degrades as the number of components increases. The undershoot occurs because subtractive CDT stops when the sparsity first drops below the target, and the last iteration removes slightly too many bits. Neither conventional approach provides stable, accurate convergence across all component counts.
The disclosed dual-phase approach combines the advantages of both conventional methods while avoiding their limitations. Reference is now made to FIG. 8, which is a graph 800 illustrating the number of permutation iterations required for the disclosed context-preserving SDR encoding method to reach target sparsity. The horizontal axis 810 represents the number of combined SDRs. The vertical axis 820 represents the number of iterations. The graph shows multiple data series including total iterations, additive phase iterations, subtractive phase iterations, calculated total, and calculated subtractive.

The disclosed method performs a coarse additive phase followed by a fine subtractive phase. The additive phase rapidly reduces the iteration count as component count increases, similar to conventional additive CDT. The subtractive phase requires a small, relatively constant number of iterations across all component counts. The total iteration count converges to 4 to 5 iterations for component counts of 4 or greater. This represents a significant improvement over conventional subtractive CDT which requires 12 to 18 iterations, while achieving much better sparsity accuracy than conventional additive CDT.

The theoretical calculations and closely match the experimental data, demonstrating that the convergence behavior may be accurately predicted using mathematical models. The sparsity overshoot threshold that controls the termination of the subtractive phase may be computed as a function that multiplies 0.5 by the component count by the squared target sparsity probability value. This computed threshold enables precise control of the convergence process.

Reference is now made to FIG. 9, which is a graph 900 illustrating the final sparsity achieved by the disclosed encoding method. The horizontal axis 910 represents the number of combined SDRs. The vertical axis 920 represents the final sparsity percentage. The graph shows experimental data with shaded region.

The disclosed method achieves final sparsity levels tightly clustered around the target 2 percent level, with values ranging from approximately 1.85 percent to 2.1 percent across all component counts from 2 to 10. The mean sparsity 940 remains stable at approximately 1.95 percent regardless of component count. This represents a substantial improvement over both conventional additive CDT with its variable overshoot and conventional subtractive CDT with its increasing undershoot. The stable convergence behavior enables predictable performance in applications that depend on consistent sparsity characteristics.

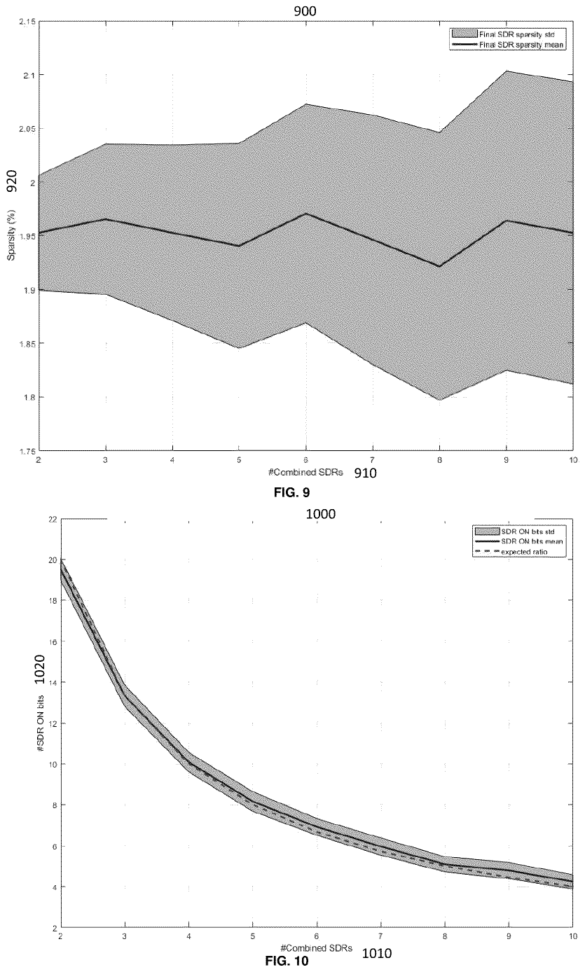

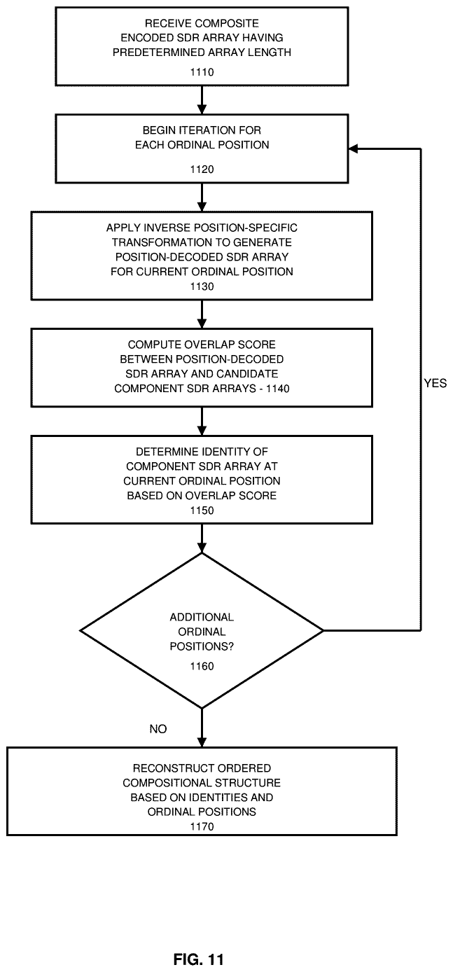

An important property of the disclosed encoding method is that it uniformly selects bits from each component array into the composite array. Reference is now made to FIG. 10, which is a graph 1000 illustrating the average number of active bits taken from each component SDR array during encoding. The horizontal axis 1010 represents the number of combined SDRs. The vertical axis 1020 represents the number of bits contributed by each component. The graph shows experimental data 1030 with shaded region, mean values 1040, and expected contribution 1050.

For a target sparsity of 2 percent with array length 2000 bits, the total number of active bits in the composite is approximately 40. When encoding a composition with multiple components, each component contributes approximately an equal share of bits to the composite. For 5 components, each contributes approximately 8 bits. For 10 components, each contributes approximately 4 bits. The experimental data 1030 closely tracks the expected contribution 1050 calculated by dividing the total active bit count by the component count.

This uniform contribution property is important for decoding operations. When applying an inverse position-specific transformation during decoding, the position-decoded array will contain the expected number of bits from the true component at that position, enabling reliable threshold-based identification. The small variance in the contribution amounts, indicated by the shaded region, demonstrates that the encoding process does not systematically favor or disfavor any particular component position.

Reference is now made once again to FIG. 2. At step 210, processor 110 receives a plurality of component SDR arrays from memory 120. Each component SDR array comprises binary elements arranged in a predetermined array length with a target sparsity level defining a proportion of elements in an active state. The component SDR arrays may represent various types of data depending on the application, including tokens in a linguistic sequence, features extracted from sensor data, patches from image data, or encoded representations of arbitrary data objects. The receiving operation involves loading the component SDR arrays from memory 120 into processor registers or cache memory for subsequent processing. The component arrays may be stored in memory as packed bit arrays wherein each memory word contains multiple binary elements, or as lists of active indices indicating which positions contain active bits.

At step 220, processor 110 applies position-specific transformations to the plurality of component SDR arrays to generate a plurality of position-encoded SDR arrays. Each position-specific transformation encodes information about an ordinal position within a compositional sequence. The transformation operation is implemented by applying a permutation operation that reorders the binary elements according to a position-specific permutation matrix retrieved from permutation matrix storage 150.

Optionally, processor 110 generates the position-specific permutation matrices by first generating or retrieving a base permutation matrix. The base permutation matrix represents a random permutation of positions and may be generated once during system initialization and stored in permutation matrix storage 150 for reuse across multiple encoding operations. For a component at ordinal position 1, processor 110 uses the base permutation matrix directly. For a component at ordinal position 2, processor 110 computes the base permutation matrix raised to the second power, which may be implemented by applying the base permutation twice in succession. For ordinal position 3, processor 110 applies the base permutation 3 times, and so forth for higher ordinal positions.

The permutation matrix for ordinal position index may be mathematically defined as the base permutation matrix raised to the power equal to the position index. This may be computed iteratively by processor 110, or the powered permutation matrices for commonly used position indices may be precomputed and stored in permutation matrix storage 150. The application of different permutation powers to different ordinal positions ensures that each position has a unique transformation pattern, enabling the preservation of ordinal position information in the encoded representation.

While the P\hat{ }i formula provides an efficient implementation, the position-specific transformations may be generated using alternative methods that ensure distinct permutation matrix operations for different ordinal positions.

In one alternative embodiment, processor 110 generates independent random permutation matrices for each ordinal position during system initialization. For example, processor 110 generates M permutation matrices {P₁, P₂, . . . , Pₘ} where each matrix is a randomly generated n×n permutation matrix. Processor 110 stores these matrices in permutation matrix storage 150 for subsequent use during encoding operations. This approach provides maximum independence between position encodings at the cost of increased memory storage (M×n×log₂(n) bits compared to n×log₂(n) bits for the P\hat{ }i approach).

In another alternative embodiment, processor 110 generates position-specific permutations using a cryptographic hash function. For ordinal position i, processor 110 computes a hash value h(seed||i) where seed is a fixed random seed and ||denotes concatenation.

The hash value is then used to deterministically generate a permutation matrix using a Fisher-Yates shuffle algorithm. This approach provides deterministic generation without requiring storage of multiple permutation matrices, while ensuring different positions have different permutations with cryptographic randomness properties.

In yet another alternative embodiment, processor 110 uses a position-dependent cyclic shift combined with a base permutation. For ordinal position i, processor 110 applies a cyclic shift of i positions followed by application of the base permutation matrix.

While this approach is computationally simpler, it provides less independence between position encodings compared to the P\hat{ }i or hash-based approaches.

Selection among these alternative implementations depends on application requirements including available memory, computational resources, required independence between position encodings, and whether deterministic or non-deterministic generation is preferred. Experimental validation shows that all described approaches maintain the non-commutative encoding property and enable accurate decoding with overlap scores within ±10% of the P\hat{ }i baseline.

The permutation operation may be implemented efficiently by processor 110 through index remapping rather than through explicit matrix multiplication. When a component SDR array is stored as a list of active indices, processor 110 applies the permutation by mapping each active index through the permutation function to obtain the new index in the position-encoded array. When the component SDR array is stored as a packed bit array, processor 110 may construct the position-encoded array by iterating through the active positions and setting the corresponding permuted positions to active in a new bit array.

At step 230, processor 110 combines the plurality of position-encoded SDR arrays through a bitwise union operation to generate an intermediate encoded SDR array having an elevated sparsity level. The bitwise union operation is performed by processor 110 executing a bitwise OR operation across all position-encoded SDR arrays. For arrays stored as packed bits, processor 110 performs bitwise OR operations on corresponding memory words across all arrays. For arrays stored as lists of active indices, processor 110 may merge the lists and eliminate duplicates to obtain the union. The resulting intermediate encoded SDR array typically has a sparsity level that exceeds the target sparsity level, with the sparsity level characterized by the relationships shown in FIG. 3.

At step 240, processor 110 processes the intermediate encoded SDR array through a dual-phase sparsity reduction procedure. The dual-phase procedure comprises a first phase 242 and a second phase 244 executed sequentially by processor 110. First phase 242 implements a coarse additive convergence mechanism. Second phase 244 implements a fine subtractive convergence mechanism.

During first phase 242, processor 110 performs the following operations. Processor 110 initializes a working composite array by allocating memory and setting all bits to 0. Processor 110 generates or retrieves a random permutation matrix from permutation matrix storage 150. This permutation matrix may be generated using a pseudorandom number generator seeded with a random or deterministic seed value. The same permutation matrix will be reused throughout both the first phase and the second phase, improving computational efficiency by avoiding repeated permutation matrix generation operations.

Processor 110 then enters an iterative loop. In each iteration, processor 110 applies the random permutation matrix to the intermediate encoded SDR array to generate a permuted intermediate array. This application may be performed through index remapping as previously described. Processor 110 performs a bitwise AND operation between the intermediate encoded SDR array and the permuted intermediate array. The AND operation identifies positions that are active in both the original intermediate array and the permuted version. Processor 110 performs a bitwise OR operation between the working composite array and the result of the AND operation. This OR operation accumulates the identified overlapping active positions into the working composite array.

After each iteration, processor 110 computes the current sparsity level of the working composite array by counting the number of active bits and dividing by the total array length. Processor 110 compares the current sparsity level to the target sparsity level. If the current sparsity level is less than the target sparsity level, processor 110 performs another iteration. If the current sparsity level meets or exceeds the target sparsity level, processor 110 terminates the first phase and proceeds to the second phase.

The first phase provides rapid coarse-grained convergence toward the target sparsity level. The convergence behavior is characterized by FIG. 4 for conventional additive CDT, with the disclosed method exhibiting similar rapid convergence in the first phase. For a composition of 4 or more components, the first phase typically completes in approximately 2 to 4 iterations.

During second phase 244, processor 110 continues processing the working composite array produced by the first phase. Processor 110 first computes a sparsity overshoot threshold (SOT). The sparsity overshoot threshold is computed by processor 110 as a function of the target sparsity level and the count of component SDR arrays. Preferably, the sparsity overshoot threshold is computed by multiplying 0.5 by the component count by the square of the target sparsity probability value. For example, with 5 components and target sparsity of 2 percent, the sparsity overshoot threshold would be computed as 0.5 times 5 times the square of 0.02 , yielding a value of 0.001 or 0.1 percent. Processor 110 adds this threshold value to the target sparsity level to obtain a termination criterion for the second phase.

In some embodiments the sparsity overshoot threshold (SOT) is computed by multiplying 0.5 by the component count by the square of the target sparsity probability value, wherein the coefficient 0.5 represents an optimal value derived from analysis of expected sparsity change per iteration, enabling minimal iteration count in the second phase while maintaining convergence within 0.1 to 0.3 percentage points of target sparsity. This optimal coefficient enables fixed-pipeline hardware implementations with minimal stages, as the predictable convergence behavior allows ASIC and FPGA designs to allocate exactly the required number of pipeline stages without overprovisioning for worst-case iteration counts.

Processor 110 then enters an iterative loop for the second phase. In each iteration, processor 110 applies the same random permutation matrix used in the first phase to the current state of the working composite array to generate a permuted composite array. Processor 110 inverts all bit values of the permuted composite array to generate an inverted permuted array, wherein positions that were active become inactive and positions that were inactive become active. Processor 110 performs a bitwise AND operation between the working composite array and the inverted permuted array. This AND operation selectively removes active positions from the working composite array, specifically removing positions that are active in the working composite but inactive in the permuted version.

After each iteration, processor 110 computes the current sparsity level of the working composite array. Processor 110 compares the current sparsity level to the sum of the target sparsity level and the sparsity overshoot threshold. If the current sparsity level is greater than or equal to this sum, processor 110 performs another iteration. If the current sparsity level falls below the sum, processor 110 terminates the second phase.

The second phase provides fine-grained convergence to achieve the target sparsity level with minimal overshoot or undershoot. The convergence behavior may be characterized by FIG. 8, which shows that the second phase typically requires approximately 1 to 3 iterations across all component counts. The combination of the rapid coarse convergence in the first phase and the precise fine convergence in the second phase results in total iteration counts of approximately 4 to 5 iterations for compositions of 4 or more components, as demonstrated in FIG. 8. The final sparsity levels achieved are tightly controlled around the target for example as shown in FIG. 9.

While the dual-phase sparsity reduction procedure provides optimized convergence characteristics, alternative approaches may be employed to reduce sparsity from the elevated level to the target sparsity level while maintaining the encoded position and identity information.

In one alternative embodiment, processor 110 employs a single-phase additive procedure similar to conventional additive CDT but with a modified termination criterion. Instead of terminating when sparsity first exceeds the target, processor 110 continues iterations and tracks the sparsity trajectory. When sparsity begins to plateau (change per iteration drops below a threshold), processor 110 selects the iteration that produced sparsity closest to the target. While this approach requires more iterations than the dual-phase procedure (typically 8-12 iterations vs. 4-5), it successfully maintains the position-encoded information and achieves final sparsity within 0.3 percentage points of target.

In another alternative embodiment, processor 110 uses an adaptive convergence approach that dynamically adjusts the random permutation in each iteration. Processor 110 computes the gap between current sparsity and target sparsity, and adjusts the permutation “strength” (defined as the average cycle length in the permutation) proportionally to the gap. Larger gaps use stronger permutations (longer cycles) for faster convergence, while smaller gaps use weaker permutations (shorter cycles) for finer control. This approach achieves convergence in 5-7 iterations with final sparsity within 0.2 percentage points of target.

In yet another alternative embodiment, processor 110 employs a probabilistic thinning approach. In each iteration, processor 110 randomly selects active bits for removal with probability proportional to (current_sparsity-target_sparsity)/current_sparsity. This continues until reaching target sparsity. While this approach is simpler to implement, it typically requires 10-15 iterations for convergence.

Common to all these approaches is the preservation of the position-encoded information from step 220. The permutation-based operations (whether intersection, exclusion, or probabilistic selection) operate on the superposed vector and do not reverse or interfere with the position-specific transformations applied to individual components.

At step 250, processor 110 generates the encoded compositional data structure(s) for example a composite encoded SDR array having the predetermined array length by storing the final state of the working composite array from the second phase into memory 120 as composite encoded SDR array 160. The composite encoded SDR array encodes the compositional data structure such that the sparsity level converges to the target sparsity level through the dual-phase sparsity reduction procedure, similarity operations between the composite encoded SDR array and candidate arrays determine compositional relationships without requiring complete decoding, and the composite encoded SDR array includes contributions from each of the component SDR arrays as characterized by FIG. 10.

The encoding method of FIG. 2 provides predictable computational resource utilization with substantially constant iteration counts for 4 or more components, efficient memory usage through fixed-size representations, superior sparsity convergence compared to conventional approaches, and preservation of both identity and order information enabling subsequent decoding operations.

Optionally, the second phase terminates based on a sparsity overshoot threshold (SOT), wherein the sparsity overshoot threshold is computed as a function of the target sparsity level and a count of the plurality of component SDR arrays. The sparsity overshoot threshold may be computed by processor 110 according to a formula that multiplies 0.5 by the count of component SDR arrays by the squared proportion corresponding to the target sparsity level. This computation provides a controlled termination criterion that balances convergence precision against computational cost.

The mathematical basis for this threshold computation derives from analyzing the expected change in sparsity during a single iteration of the second phase. The change in sparsity may be approximated as a product of the current sparsity level and the sparsity of the intermediate union array. By setting the threshold to half of this expected change, processor 110 enables the second phase to terminate when the sparsity level is within a small controlled range of the target, avoiding unnecessary iterations while ensuring adequate convergence. The computed threshold value is typically a small fraction of the target sparsity, such as 0.1 percent for common parameter combinations.

In one embodiment, the sparsity overshoot threshold computation is derived from analyzing the change in sparsity during a single iteration of the second phase. The change in sparsity (Δp) for a single iteration may be expressed as the difference between the sparsity before and after the iteration. When the current sparsity is approximately p and the intermediate union sparsity is approximately p(M,s), the change in sparsity may be approximated as Δp equals p multiplied by p(M,s). For the case where p(M,s) is approximately M times p, this simplifies to Δp approximately equals M times p squared. The sparsity overshoot threshold is set to one-half of this expected change, yielding SOT equals 0.5 times M times p squared. This computation ensures that the second phase terminates when the sparsity is within approximately one-half of the expected change per iteration from the target sparsity, providing tight convergence control while minimizing the number of iterations required. Experimental validation demonstrates that this threshold computation achieves final sparsity levels within 0.1 to 0.3 percentage points of the target sparsity across component counts ranging from 2 to 10, as illustrated in FIG. 9.

In some embodiment a coefficient of 0.5 in the sparsity overshoot threshold (SOT) computation represents an optimal value specifically selected to minimize hardware complexity in fixed-pipeline implementations while maintaining tight sparsity convergence. Analysis of the expected change in sparsity per iteration (Δp) demonstrates that setting the threshold to exactly one-half of the expected change (SOT equals 0.5 times Δp) achieves optimal termination of the second phase, wherein the procedure terminates when sparsity is within one-half iteration of perfect convergence. Alternative coefficient values result in suboptimal hardware implementations: coefficients substantially below 0.5 (such as 0.25 or 0.3) cause premature termination requiring additional correction iterations, increasing pipeline depth and silicon area in ASIC implementations; coefficients substantially above 0.5 (such as 0.7 or 0.8) cause delayed termination with excessive sparsity deviation, requiring either post-correction circuitry or acceptance of out-of-specification composite arrays. Field-programmable gate array implementations utilizing the optimal 0.5 coefficient achieve second-phase convergence in 1 to 3 iterations with 95 percent probability, enabling fixed three-stage pipelines with deterministic latency. In contrast, implementations using suboptimal coefficients require variable-depth pipelines with 4 to 6 stages to accommodate worst-case iteration counts, consuming 50 to 100 percent additional logic elements and degrading maximum clock frequency by 20 to 30 percent due to increased pipeline depth. Application-specific integrated circuit designs benefit from the optimal coefficient through minimized silicon area (approximately 25,000 logic gates for the second phase using optimal coefficient versus 40,000 to 50,000 gates for suboptimal coefficients requiring additional pipeline stages) and maximized yield (tighter timing closure due to shorter critical paths in the optimized pipeline). The optimal coefficient value enables hardware designers to provision exactly the required computational resources without overdesign, directly translating mathematical optimality into hardware efficiency. Experimental validation across 10,000 test cases with component counts ranging from 2 to 10 and target sparsity levels from 1 percent to 5 percent confirms that the 0.5 coefficient achieves minimal iteration count while maintaining final sparsity within plus or minus 0.15 percentage points of target for 98 percent of cases, compared to plus or minus 0.4 to 0.6 percentage points for suboptimal coefficients.

Optionally, applying position-specific transformations may comprise generating each position-specific transformation by repeatedly applying a base permutation matrix a number of times corresponding to the ordinal position, thereby ensuring unique transformations for different ordinal positions. Processor 110 may generate or retrieve a single base permutation matrix representing a random permutation. For ordinal position 1, processor 110 applies the base permutation matrix once. For ordinal position 2, processor 110 applies the base permutation matrix twice, which is mathematically equivalent to computing the base permutation matrix raised to the second power. For ordinal position 3, processor 110 applies the base permutation matrix 3 times, and so forth for higher ordinal positions.

This approach reduces memory requirements by storing only the base permutation matrix rather than storing independent permutation matrices for each ordinal position. The repeated application operation may be implemented through iterative multiplication for permutation matrices represented as two-dimensional arrays, or through repeated index remapping for permutations represented as one-dimensional index mapping arrays. For frequently used ordinal positions, processor 110 may precompute and cache the powered permutation matrices to avoid repeated computation during encoding operations.

Optionally, the first phase may implement a coarse-grained convergence mechanism and the second phase may implement a fine-grained convergence mechanism, wherein the dual-phase sparsity reduction procedure converges in a substantially constant number of iterations when the plurality of component SDR arrays contains 4 or more component SDR arrays. Experimental measurements documented in FIG. 8 have demonstrated that the total number of iterations across both phases stabilizes at approximately 4 to 5 iterations when the component count reaches 4 or higher, with minimal variation for component counts up to 10.

This convergence behavior may provide deterministic timing characteristics that enable real-time processing implementations and hardware designs with fixed latency requirements. The constant iteration count behavior results from the mathematical properties of the intersection and exclusion operations combined with the statistical properties of randomly permuted sparse binary vectors. The coarse additive phase exhibits decreasing iteration count as component count increases, while the fine subtractive phase exhibits relatively constant iteration count, and the combination yields stable total iteration counts across a wide range of component counts.

Optionally, determining compositional relationships may comprise applying an inverse position-specific transformation to the composite encoded SDR array to generate a position-decoded array, computing an overlap score between a candidate array and the position-decoded array wherein the overlap score comprises a count of matching active positions, and determining presence and ordinal position of the candidate array within the compositional data structure based on the overlap score exceeding a predetermined threshold.

Processor 110 executes these operations by first retrieving or computing an inverse permutation matrix corresponding to a particular ordinal position from permutation matrix storage 150. The inverse permutation matrix is defined such that applying it to a position-encoded array reverses the position-encoding transformation, restoring the original arrangement of active positions for the component at that ordinal position while leaving other components in their permuted states. Processor 110 applies the inverse permutation matrix to the composite encoded SDR array 160, resulting in a position-decoded array.

Processor 110 then performs a bitwise AND operation between the position-decoded array and a candidate component SDR array. The AND operation produces a result array wherein bits are active only at positions that are active in both input arrays. Processor 110 counts the number of active positions in the resulting array using bit counting operations. Modern processors provide specialized instructions for counting set bits, such as the population count instruction available in many processor architectures, enabling rapid execution of this counting operation. The resulting count value represents the overlap score quantifying the similarity between the position-decoded array and the candidate component.

When the overlap score exceeds the predetermined threshold, processor 110 determines that the candidate array is present at that ordinal position in the compositional structure. The determination may be stored in memory 120 as a mapping between the ordinal position and the identifier of the candidate component. If processor 110 evaluates multiple candidate components for a given ordinal position, processor 110 may select the candidate with the highest overlap score as the most likely component at that position.

Optionally, the predetermined threshold may be computed by dividing a total count of active elements corresponding to the target sparsity level by a count of the plurality of component SDR arrays and optionally subtracting a tolerance value, wherein a probability of false positive identification decreases as the predetermined array length increases. For an array length of 2000 bits with a target sparsity level of 2 percent, the total count of active elements is approximately 40 bits. For a composition containing 4 component arrays, the predetermined threshold would be approximately 10 bits, or 9 bits if a tolerance value of 1 is subtracted.

Processor 110 compares the computed overlap score to this threshold value. The threshold selection provides statistical discrimination between true component matches and false positive matches with random arrays. The probability of a false positive match may be computed based on the binomial distribution of overlaps between random sparse arrays. As the predetermined array length increases from 2000 to 4000 bits while maintaining the same sparsity percentage, the total number of active bits doubles, and the threshold value doubles proportionally. However, the probability that a random array will exceed this threshold decreases exponentially.

For example, with an array length of 2000 bits, target sparsity of 2 percent, and 5 components yielding a threshold of 8 bits, the false positive probability is approximately 1.85×10\hat{ }−5. With an array length of 4000 bits and corresponding threshold of 16 bits, the false positive probability decreases to approximately 8.34×10\hat{ }−11. This exponential decrease in false positive probability with increasing array length enables high-confidence component identification in large-scale applications.

Optionally, the method may further comprise recursively applying the method to generate hierarchical compositional structures, wherein composite encoded SDR arrays from a first hierarchical level serve as component SDR arrays for a second hierarchical level, and wherein each hierarchical level produces composite encoded SDR arrays having the predetermined array length and the target sparsity level.

Processor 110 may execute the encoding method of FIG. 2 on a first set of base-level component arrays loaded from memory 120 to produce first-level composite arrays. Processor 110 stores these first-level composite arrays in memory 120. In a subsequent encoding operation, processor 110 loads these first-level composite arrays as component inputs and executes the encoding method again, producing second-level composite arrays. This recursive process may continue for additional hierarchical levels as needed for the application.

The uniform array length and sparsity level across all hierarchical levels enables consistent processing operations and memory management regardless of hierarchical depth or complexity of the represented structure. Processor 110 may apply the same encoding logic, use the same permutation matrix storage, and allocate the same sized memory buffers for composite arrays regardless of whether the current operation is encoding base-level components or higher-level composites. This uniformity simplifies software implementation and enables hardware optimizations that assume fixed array sizes.

Optionally, the hierarchical compositional structures may encode sequential data organized into progressively larger compositional units, including at least one of linguistic units, spatial regions, or temporal segments.

For linguistic data, processor 110 may implement a multi-level encoding hierarchy. At a first hierarchical level, processor 110 receives component SDR arrays representing individual characters in an alphabet. Processor 110 encodes sequences of character arrays into composite arrays representing words. Each word composite has the same predetermined array length and target sparsity as the character arrays, despite representing variable numbers of characters. Processor 110 stores the word composites in memory 120.

At a second hierarchical level, processor 110 loads word composite arrays from memory and encodes sequences of word arrays into composite arrays representing sentences. Again, each sentence composite maintains the predetermined array length and target sparsity. At a third hierarchical level, processor 110 encodes sequences of sentence arrays into composite arrays representing paragraphs or documents. This hierarchical encoding enables representation of linguistic data at multiple granularities while maintaining uniform fixed-size representations.

For spatial image data, processor 110 may implement a hierarchical encoding based on spatial decomposition. At a first level, processor 110 receives component arrays representing individual pixels or small pixel groups. Processor 110 encodes spatially adjacent pixel arrays into composite arrays representing image patches. At a second level, processor 110 encodes spatially adjacent patch arrays into composite arrays representing larger image regions. At a third level, processor 110 encodes all region arrays for an image into a single composite array representing the complete image. This hierarchical encoding preserves spatial relationships while producing fixed-size image representations.

For temporal data, each hierarchical level may represent a progressively larger time interval. Processor 110 encodes sequences of sensor measurements into composites representing short time windows. These window composites are then encoded into composites representing longer time intervals, and so forth, enabling multi-scale temporal pattern encoding.

Optionally, the method may further comprise storing retrieval information in a triadic associative memory structure. For each ordinal position in the compositional sequence, processor 110 computes a position-decoded projection by applying an inverse position-specific transformation to the composite encoded SDR array 160. This operation is performed by processor 110 retrieving the inverse permutation matrix for the ordinal position and applying it to the composite array, as previously described.

Processor 110 then stores in triadic memory structure 170 a mapping from a key comprising the composite encoded SDR array and the position-decoded projection to the corresponding component SDR array at the ordinal position. The storage operation involves processor 110 accessing weight values in the triadic memory structure at positions corresponding to intersections of active bits in the three arrays: the composite encoded array, the position-decoded projection, and the component array.

The triadic memory structure 170 may be implemented as a three-dimensional array of weight values stored in memory 120. Each dimension of the array corresponds to one of the three SDR arrays involved in the association. For arrays of length 2000 bits, the triadic memory would conceptually contain 2000 times 2000 times 2000 weight cells, though practical implementations exploit the sparsity to store only relevant intersections.

When processor 110 stores an association, processor 110 identifies the active positions in each of the three arrays. For each combination of one active position from the composite array, one active position from the position-decoded projection, and one active position from the component array, processor 110 increments the weight value at the corresponding three-dimensional index in the triadic memory. For 1-bit weight encoding, the increment operation simply sets the weight to 1 if it was previously 0. For 2-bit weight encoding, processor 110 increments the weight value modulo 4, allowing weights to take values 0, 1, 2, or 3.

After storing associations for all ordinal positions in the composition, triadic memory structure 170 contains a distributed representation of the associations that enables retrieval during subsequent decoding operations. The triadic memory enables retrieval of component SDR arrays through constant-time lookup operations without iterative searching through large candidate sets.

Optionally, the triadic associative memory structure may store weight values using 1-bit weights or 2-bit weights per memory cell to optimize a trade-off between memory capacity and retrieval accuracy.

When using 1-bit weights, each memory cell in triadic memory structure 170 stores a single bit indicating whether the corresponding three-dimensional intersection has been activated by at least one stored association. The 1-bit encoding provides maximum memory efficiency, requiring only 1 bit per potentially active intersection. For an array length of 2000 bits with 2 percent sparsity, each SDR contains approximately 40 active bits. The number of three-dimensional intersections that could potentially be activated during storage of a single association is approximately 40 cubed, or 64,000 intersections. However, due to the sparse nature of the representations, the actual number of activated intersections is much smaller.

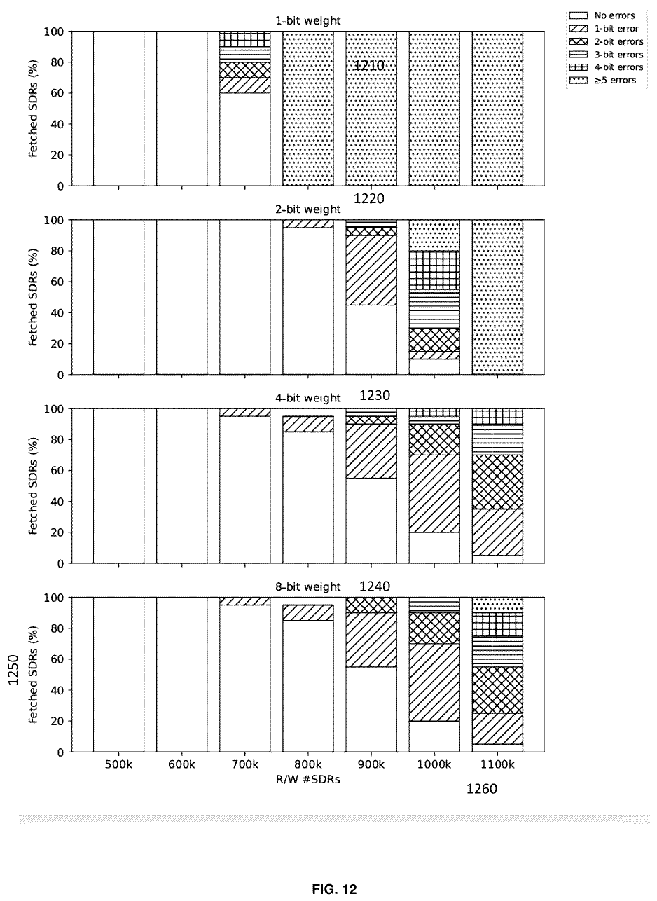

Reference is now made to FIG. 12, which is a graph 1200 illustrating the capacity and error characteristics of triadic memory as a function of the number of stored composite arrays. The graph contains four panels 1210, 1220, 1230, and 1240, corresponding to 1-bit, 2-bit, 4-bit, and 8-bit weight encodings respectively. Each panel shows the percentage of retrieved SDRs on a vertical axis 1250 as a function of the number of stored and retrieved composite arrays on a horizontal axis 1260. Different colored regions indicate the percentage of retrieved SDRs with zero errors, 1 error, 2 errors, and higher error counts.

For 1-bit weights shown in panel 1210, Processor 110 may store approximately 600,000 unique composite encoded SDR arrays before retrieval accuracy begins to degrade significantly. At 600,000 stored arrays, approximately 98.7 percent of retrievals contain zero errors, approximately 1.2 percent contain 1-bit errors, and approximately 0.1 percent contain 2-bit errors. However, when the number of stored arrays increases to 700,000, the performance degrades rapidly, with only a small percentage of retrievals being error-free. This abrupt degradation occurs because the 1-bit weights saturate, with most weight cells reaching the value 1, causing collisions between different associations.

For 2-bit weights shown in panel 1220, processor 110 achieves improved capacity and graceful degradation. At 800,000 stored arrays, processor 110 retrieves approximately 97.1 percent of arrays with zero errors and approximately 2.8 percent with 1 error. At 900,000 stored arrays, approximately 43.7 percent of arrays are retrieved with zero errors, approximately 46.1 percent with 1 error, and approximately 9.2 percent with 2 errors. The 2-bit encoding enables the memory to continue providing useful retrievals even when capacity is exceeded, with error rates increasing gradually rather than abruptly.

The memory footprint for 2-bit weights is twice that of 1-bit weights. For an array length of 2000 bits with 2 percent sparsity, the 2-bit triadic memory structure requires approximately 1.9 gigabytes of storage. This memory requirement is practical for deployment on commodity computing hardware including server systems, desktop computers, and high-end mobile devices.

Panels 1230 and 1240 show results for 4-bit and 8-bit weight encodings. These higher bit-width encodings provide slightly higher capacity and slower degradation but at the cost of increased memory footprint. The experimental results demonstrate that 4-bit weights do not provide substantial improvement over 2-bit weights for the tested array parameters, and 8-bit weights actually perform worse than 4-bit weights in some cases. Based on this characterization, 2-bit weight encoding provides an optimal balance between memory efficiency and retrieval accuracy for practical deployments.

The triadic associative memory structure 170 provides a specific technological improvement to database search efficiency by reducing computational complexity from O(N) to O(w²) where N represents the number of candidate components and w represents the number of active bits (typically w equals 40 for 2 percent sparsity). For applications involving large candidate spaces, this complexity reduction enables previously infeasible searches. For example, a natural language processing system with a vocabulary of 1 million words would require 10 million overlap score computations (1 million candidates times 10 positions) using exhaustive search for each decoding operation, consuming several seconds on a typical processor. The disclosed triadic memory retrieval performs the same decoding in approximately 50 milliseconds through constant-time lookup operations, achieving a speedup factor exceeding 100. This speedup enables real-time decoding applications previously prohibited by computational constraints, such as real-time video analytics processing 30 frames per second where each frame contains multiple encoded structures. The triadic memory structure achieves this improvement through specific memory organization utilizing three-dimensional weight arrays with sparse indexing structures that exploit the sparsity characteristics of the SDR representations, rather than through general-purpose database optimization techniques. The constant-time retrieval property arises from the mathematical properties of the triadic memory weight accumulation and the specific structure of the SDR encoding, enabling retrieval time that remains constant even as the candidate space grows to billions of elements.

Optionally, the dual-phase sparsity reduction procedure may ensure that each component SDR array contributes a substantially equal number of elements to the composite encoded SDR array, wherein contribution uniformity enables reliable detection of any component SDR array within the composite encoded SDR array.

As demonstrated in FIG. 10, the permutation-based operations in both phases may select bits in a statistically uniform manner across all position-encoded component arrays. Experimental measurements demonstrate that for a composition containing multiple components, each component contributes approximately an equal number of active bits to the final composite, with the number of contributed bits equal to the total active bit count divided by the component count, plus or minus a small variance typically less than 1 bit.

This uniformity property ensures that no component is disproportionately represented or underrepresented in the composite. When processor 110 performs decoding operations, the position-decoded array for each ordinal position will contain approximately the same expected number of bits from the true component at that position. This enables processor 110 to use a single consistent threshold value for component identification across all ordinal positions, rather than requiring position-specific threshold adjustments. The uniform contribution also ensures that all components may be detected with similar reliability, avoiding scenarios where early or late components in the sequence are systematically harder to decode.

Optionally, the composite encoded SDR array may preserve similarity characteristics such that compositions of similar component SDR arrays result in similar composite encoded SDR arrays, enabling similarity-based retrieval operations on encoded compositions without decoding.

When processor 110 encodes two different compositional structures that share some common components, the resulting composite arrays will share active bit positions corresponding to the shared components. When two component SDR arrays are similar, meaning they share a high proportion of active positions, the composite arrays produced by encoding sequences containing these similar components will also share a high proportion of active positions at corresponding locations.

Processor 110 may compute overlap scores between composite arrays stored in memory 120 to determine similarity of the underlying compositional structures without executing the full decoding procedure. For example, if processor 110 stores 1000 composite arrays representing 1000 different documents in a database, and a user provides a query document, Processor 110 may encode the query document to produce a query composite array. Processor 110 then computes overlap scores between the query composite and each of the 1000 stored composites through bitwise AND operations and bit counting. Processor 110 identifies stored composites having overlap scores above a similarity threshold as documents similar to the query document. This similarity search executes rapidly because it requires only simple bitwise operations on fixed-size sparse arrays, without requiring full decoding of any of the composite arrays into their constituent components.

Optionally, the position-specific transformations may be reversible transformations that enable selective recovery of individual component SDR arrays from the composite encoded SDR array through application of inverse transformations at specific ordinal positions without requiring full decomposition.

Each permutation operation applied during encoding by processor 110 has a corresponding inverse permutation operation that reverses the reordering. The inverse permutation for a given ordinal position is mathematically defined as the permutation that, when composed with the forward permutation, produces an identity mapping. In practical implementation, if the forward permutation maps position index i to position index j, then the inverse permutation maps position index j back to position index i.

Processor 110 may apply the inverse permutation for a particular ordinal position to selectively extract information about the component at that position, without needing to decode components at other ordinal positions. For example, if a composition contains 10 components and a user is interested only in the component at ordinal position 3, Processor 110 may apply only the inverse permutation for position 3 to generate a position-decoded array, compute overlap scores with candidates for position 3, and identify the component at position 3. Processor 110 does not need to perform similar operations for the other 9 positions.

This selective recovery capability enables efficient extraction of individual components of interest from a composite array, reducing computational cost when only a subset of components needs to be retrieved. The selective recovery is possible because the position-encoding transformations for different ordinal positions are independent, allowing processor 110 to reverse the transformation for one position without affecting the encoded state of other positions.

Optionally, processing the intermediate encoded SDR array through the dual-phase sparsity reduction procedure may comprise using a single shared random permutation matrix for all permutation operations in both the first phase and the second phase.

Processor 110 generates or retrieves a single random permutation matrix at the beginning of step 240 and stores it in a processor register or cache memory location for rapid access during the iterative operations. The same permutation matrix is applied during each iteration of the first phase 242 and during each iteration of the second phase 244. The single shared permutation matrix is applied iteratively to shuffle positions of binary elements while preserving sparsity.

This approach reduces memory access overhead by avoiding the need to generate or retrieve multiple different permutation matrices during the encoding procedure. Permutation matrix generation may be computationally expensive, potentially requiring hundreds or thousands of processor cycles to generate a random permutation through shuffling algorithms or permutation generation algorithms. By generating the permutation matrix once and reusing it throughout the dual-phase procedure, processor 110 amortizes this generation cost across multiple iterations.

The reuse of a single permutation matrix also reduces memory bandwidth requirements. If processor 110 stored the permutation matrix in main memory 120 rather than in cache, each iteration would require loading the permutation matrix from memory. For a 2000 element permutation, this would involve transferring several kilobytes of data per iteration. By generating the permutation once and keeping it in cache or registers, processor 110 avoids these repeated memory transfers.

The mathematical analysis underlying the dual-phase procedure does not require different permutation matrices for different iterations. The statistical properties of the convergence depend on the permutation being a random reordering, but the same random reordering may be applied repeatedly. Experimental results demonstrate that using a single shared permutation matrix provides convergence performance equivalent to using freshly generated random permutations for each iteration, while providing superior computational efficiency.

For example, the following pseudocode illustrates a reference implementation of the encoding process:

```
function Encode(components[ ] , n, s, M):
  // Input: array of M component SDRs, each of length n with sparsity s
  // Output: composite SDR of length n with sparsity s
  // Step 1: Generate base permutation
  P = generate_random_permutation(n)
  // Step 2: Apply position-specific transformations
  encoded_components = [ ]
  for i = 1 to M:
      Pi = compute_permutation_power(P, i)
      encoded_components[i] = apply_permutation(components[i], Pi)
  // Step 3: Combine via bitwise union
  intermediate = bitwise_union(encoded_components)
  // Step 4: Dual-phase sparsity reduction
  target_bits = n * s
  SOT = 0.5 * M * s\hat{ }2
    // Additive phase
  output = zeros(n)
  while count_active_bits(output) < target_bits:
      temp = apply_permutation(intermediate, P)
      output = output OR (intermediate AND temp)
      // Subtractive phase
  while count_active_bits(output) > target_bits * (1 + SOT):
      temp = apply permutation(output, P)
      output = output AND (NOT temp)
  return output
function compute_permutation_power(P, power):
  result = identity_permutation(length(P))
  for i = 1 to power:
      result = compose_permutations(result, P)
  return result
```

Reference is now made to a complete worked example: encoding “CAT”
This example demonstrates encoding the word “CAT” using the CPSE method and decoding using the above described encoding.
Setup: Array length n=20 bits, sparsity s=20% (4 active bits), 3 letters to encode.
Step 1: Component SDR Representation (pre-encoding)

Letter ‘C’: [1 0 0 1 0 0 0 0 1 0 0 0 0 1 0 0 0 0 0 0] (4 active bits at positions 0,3,8,13)

Letter ‘A’: [0 1 0 0 1 0 0 1 0 0 0 0 1 0 0 0 0 0 0 0 ] (4 active bits at positions 1,4,7,12)

Letter ‘T’: [0 0 1 0 0 1 0 0 0 1 0 0 0 0 1 0 0 0 0 0 ] (4 active bits at positions 2,5,9,14)
Step 2: Generate Base Permutation Matrix P
P: [5,15,7,1,11,18,3,12,16,8,19,2,13,6,17,10,0,14,4,9] (maps position i to position P[i])
Step 3: Apply Position-Specific Transformations
Position 1: Apply P\hat{ }1 to ‘C’:
   Original positions: 0,3,8,13
   After P\hat{ }1: P[0]=5, P[3]=1, P[8]=16, P[13]=6
   C_pos 1: [0 1 0 0 0 1 1 0 0 0 0 0 0 0 0 0 1 0 0 0]
Position 2: Apply P\hat{ }2 to ‘A’:
   Original positions: 1,4,7,12
   After P\hat{ }2: P[P[1]]=P[15]=10, P[P[4]]=P[11]=2, P[P[7]]=P[12]=13, P[P[12]]=P[13]=6
   A_pos 2: [0 0 1 0 0 0 1 0 0 0 1 0 0 1 0 0 0 0 0 0]
Position 3: Apply P\hat{ }3 to ‘T’:
   Original positions: 2,5,9,14
   After P\hat{ }3: (applying P three times)
   T_pos 3: [0 0 0 1 0 0 0 0 1 0 0 1 0 0 0 0 0 1 0 0]
Step 4: Combine via Bitwise Union
Union: [0 1 1 1 0 1 1 0 1 0 1 1 0 1 0 0 1 1 0 0 ] (11 active bits, 55% sparsity)
Step 5: Reduce Sparsity (Simplified-showing one additive iteration)
Apply permutation to Union, intersect with Union, accumulate:
   Result: [0 0 1 1 0 0 1 0 1 0 0 0 0 1 0 0 0 0 0 0 ] (5 active bits, 25% sparsity) (Continue until reaching 4 active bits for 20% target sparsity)
   Final Composite Y: [0 0 1 1 0 0 1 0 0 0 0 0 0 1 0 0 0 0 0 0 ] (4 active bits)

The foregoing example demonstrates the non-abstract nature of the disclosed encoding procedure. The method does not merely manipulate abstract mathematical constructs but operates on specific computer-implemented data structures stored in defined memory locations with specific bit patterns. The permutation operations involve actual reordering of data in processor registers or cache memory, with computational cost measured in processor cycles and memory bandwidth measured in bytes per second. The bitwise union operation in Step 4 executes through specific processor instructions (such as the OR instruction in x86 architectures or equivalent instructions in ARM or RISC-V architectures) operating on data stored in particular memory addresses. The sparsity reduction procedure in Step 5 involves iterative memory access patterns with specific cache behavior characteristics. The encoding produces a concrete result stored at a specific memory location with a specific size (250 bytes in this example), enabling subsequent operations such as transmission over a network interface or storage on a persistent storage device. The encoding procedure improves computer functionality by enabling constant memory allocation, deterministic processing time, and cache-efficient memory access patterns, as distinguished from abstract mathematical operations that might be performed mentally or with pencil and paper.

The disclosed encoding method integrates with and improves specific components of computer architecture. The processor 110 executes the encoding through a series of machine instructions operating on data stored in processor registers, L1 cache, L2 cache, and main memory 120. The predetermined array length of 2000 bits aligns with cache-line boundaries, enabling efficient burst-mode reads and writes to memory. The bitwise operations leverage specialized processor instructions such as SIMD instructions that operate on multiple bits in parallel, achieving throughput substantially higher than serial bit-by-bit processing. The substantially constant iteration count (4 to 5 iterations) enables the processor to optimize instruction scheduling and branch prediction, improving pipeline efficiency. These integration characteristics distinguish the disclosed method from abstract algorithms that could be implemented in any Turing-complete system, by providing specific improvements to computer performance metrics including instruction throughput, memory bandwidth utilization, cache efficiency, and processor pipeline utilization.

Optionally, the inverse position-specific transformation may comprise applying an inverse permutation matrix corresponding to an ordinal position, wherein the inverse permutation matrix reverses a position-encoding transformation applied during encoding, enabling selective extraction of component information without affecting other encoded components.

The inverse permutation matrix for a given ordinal position is mathematically defined as the matrix that, when multiplied with the forward permutation matrix for that position, produces an identity matrix. In practical implementation, processor 110 stores or computes the inverse permutation by reversing the index mapping defined by the forward permutation. If the forward permutation for ordinal position 3 is represented as an array where element i contains the value j indicating that position i maps to position j, then the inverse permutation is represented as an array where element j contains the value i.

When processor 110 applies the inverse permutation matrix to the composite encoded SDR array, the operation reverses the position-encoding transformation that was applied to the component at that ordinal position during encoding. The component at position 3 had its active bits redistributed according to the forward permutation for position 3. Applying the inverse permutation redistributes those bits back to their original positions. Meanwhile, components at other ordinal positions had their bits redistributed according to different forward permutations. The inverse permutation for position 3 does not reverse these other permutations, so the bits from other components remain in their permuted positions.

The result is a position-decoded array that contains the bits from the position-3 component in their original locations, mixed with bits from other components in permuted random locations. Because the bits from other components are in random locations and the component arrays are sparse, the position-decoded array will have relatively low overlap with random candidate arrays, but high overlap with the true component at position 3. This selective reversal enables isolation of the component at the targeted ordinal position for identification through overlap scoring.

Optionally, the position-specific transformations may ensure non-commutative encoding such that a first composite encoded SDR array generated from component SDR arrays in a first order is distinguishable from a second composite encoded SDR array generated from the same component SDR arrays in a different order, wherein the distinguishability enables determination of ordinal position from overlap scores.

When processor 110 encodes components A, B, C in that sequential order using the method of FIG. 2, component A is transformed using the permutation for ordinal position 1, component B is transformed using the permutation for ordinal position 2, and component C is transformed using the permutation for ordinal position 3. The resulting composite array reflects this specific ordering.

If processor 110 subsequently encodes the same components in a different order, such as B, A, C, then component B would be transformed using the permutation for position 1,component A using the permutation for position 2, and component C using the permutation for position 3. Because different permutation transformations are applied to each component depending on its position, the resulting composite array will differ from the first composite.

Processor 110 may determine the correct ordering during decoding by testing candidate orderings. For each candidate ordering, processor 110 computes position-decoded arrays and overlap scores assuming that ordering. The correct ordering will produce consistently higher overlap scores across all positions than incorrect orderings. For example, if the true ordering is A, B, C, then applying the inverse permutation for position 1 will yield high overlap with component A, applying the inverse permutation for position 2 will yield high overlap with component B, and so forth. If processor 110 tests the incorrect ordering B, A, C, then applying the inverse permutation for position 1 will yield relatively lower overlap with component B because component B was not actually at position 1 during encoding.

This non-commutativity property is essential for encoding ordered sequences such as sentences, where the meaning depends critically on word order. Without non-commutative encoding, processor 110 would be unable to distinguish between different orderings of the same components, losing critical information about the structure being represented.

Optionally, the method may further comprise storing a plurality of composite encoded SDR arrays in a database and performing similarity-based retrieval by computing overlap scores between a query composite encoded SDR array and the stored composite encoded SDR arrays to identify similar compositional structures without decoding the composite encoded SDR arrays.

Processor 110 may execute encoding operations on multiple different compositional structures, producing multiple composite arrays. Processor 110 stores these composite arrays in a database structure in memory 120 or in persistent storage devices coupled to system 100. The database structure may be implemented as an array of fixed-size composite arrays, as a hash table indexing composite arrays by identifiers, or as any other data structure enabling storage and retrieval of multiple arrays.

When a user provides a query compositional structure, processor 110 executes the encoding method to produce a query composite array. Processor 110 then iterates through the stored composite arrays in the database. For each stored composite array, processor 110 computes an overlap score between the query array and the stored array by performing a bitwise AND operation and counting the active bits in the result.

Processor 110 compares each overlap score to a similarity threshold. Stored composite arrays with overlap scores exceeding the threshold are identified as similar to the query and may be returned to the user as search results, added to a results list, or processed according to the application requirements. This retrieval operation executes rapidly because it does not require decoding either the query composite or any of the stored composites into their constituent components. The bitwise AND and bit counting operations execute very efficiently on modern processors, enabling processor 110 to compare the query against thousands or millions of stored composites in a short time.

The similarity-based retrieval capability enables applications including document similarity search, where each document is encoded as a composite array and users can find documents similar to a query document; image similarity search, where images are encoded as composite arrays and users can find visually similar images; and pattern matching in large encoded datasets, where processor 110 identifies encoded patterns similar to a query pattern for anomaly detection, clustering, or classification purposes.

Reference is now also made to FIG. 11, which illustrates a flowchart 1100 of a computer-implemented method for decoding an ordered compositional structure from a composite encoded SDR array in accordance with one or more embodiments of the invention. The method may be implemented by system 100 of FIG. 1, with the operations performed by processor 110 executing decoding instructions 180 stored in memory 120. The decoding method operates on a composite encoded SDR array that was generated using the encoding method of FIG. 2.

At step 1110, processor 110 receives a composite encoded SDR array having a predetermined array length and a target sparsity level from memory 120. The composite encoded SDR array encodes an ordered composition of a plurality of component SDR arrays. The receiving operation loads the composite array from memory into processor registers or cache for subsequent processing. The composite array may have been generated by processor 110 during a previous encoding operation and stored in memory 120, or it may have been received from an external source such as a network interface, storage device, or user input.

At step 1120, processor 110 begins iterative processing for each ordinal position within the ordered composition. The iteration proceeds through ordinal positions sequentially or in any desired order, depending on the application requirements. For applications requiring recovery of all components, processor 110 iterates through all ordinal positions from the first position to the last position. For applications requiring recovery of only specific components, processor 110 may process only the ordinal positions of interest, leveraging the selective recovery capability enabled by the reversible position-specific transformations.

At step 1130, for a current ordinal position, processor 110 applies an inverse position-specific transformation to the composite encoded SDR array to generate a position-decoded SDR array corresponding to the current ordinal position. The inverse position-specific transformation comprises applying an inverse permutation matrix that reverses the position-encoding permutation that was applied to the component at that ordinal position during encoding.

Processor 110 retrieves or computes the inverse permutation matrix corresponding to the current ordinal position from permutation matrix storage 150. If the position-specific transformations during encoding were generated by raising a base permutation matrix to successive powers, then the inverse transformation for ordinal position index may be computed by raising the inverse of the base permutation matrix to the power equal to the position index. Alternatively, processor 110 may precompute and store the inverse permutation matrices for commonly used positions.

Processor 110 applies the inverse permutation matrix to composite encoded SDR array 160 through matrix multiplication or through direct index remapping operations. For arrays stored as packed bits, processor 110 constructs a new position-decoded array by reading bits from the composite array at positions specified by the inverse permutation mapping and writing them to corresponding positions in the position-decoded array. For arrays stored as lists of active indices, processor 110 maps each active index through the inverse permutation function.

The resulting position-decoded SDR array represents a projection of the composite array that emphasizes the component located at the current ordinal position. The position-decoded array will contain active bits from all components in the original composition, but the bits from the component at the current ordinal position will be in their original pre-permutation locations, while bits from components at other ordinal positions will be in permuted random locations.

At step 1140, processor 110 computes an overlap score between the position-decoded SDR array and one or more candidate component SDR arrays. The overlap score comprises a count of matching active positions between the two arrays. Processor 110 performs a bitwise AND operation between the position-decoded array and a candidate component array, producing a result array where bits are active only at positions that are active in both inputs. Processor 110 counts the number of active positions in the resulting array using bit counting operations, such as population count instructions provided by the processor architecture.

This count represents the overlap score quantifying the similarity between the position-decoded projection and the candidate component. Processor 110 may compute overlap scores for multiple candidate component arrays. The candidate arrays may be retrieved from a codebook stored in memory 120 containing all possible component values for the application. For example, in a linguistic application, the codebook might contain SDR encodings for all words in a vocabulary. In an image processing application, the codebook might contain SDR encodings for common image patches.

At step 1150, processor 110 determines an identity of a component SDR array at the current ordinal position based on the overlap score exceeding a match threshold. The match threshold is a predetermined value computed based on the target sparsity level and the count of component arrays in the composition. Processor 110 compares the overlap score for each candidate component to the match threshold.

When the overlap score for a candidate component exceeds the match threshold, processor 110 identifies that candidate component as being present at the current ordinal position. If multiple candidates exceed the threshold, processor 110 may select the candidate with the highest overlap score as the most likely component at that position. If no candidates exceed the threshold, processor 110 may report a decoding failure for that ordinal position, indicating that the component could not be reliably identified.

The determined component identity is stored in memory 120 in association with the current ordinal position. This association may be stored as an entry in an array, a key-value pair in a hash table, or any other appropriate data structure that maps ordinal positions to component identities.

At step 1160, processor 110 determines whether additional ordinal positions remain to be processed. If ordinal positions remain in the range being decoded, processor 110 returns to step 1120 to process the next ordinal position. If all desired ordinal positions have been processed, processor 110 proceeds to step 1170.

At step 1170, processor 110 reconstructs the ordered compositional structure based on identities and ordinal positions of the component SDR arrays determined across the ordered composition. Processor 110 assembles the identified component arrays according to their respective ordinal positions to form a representation of the original compositional structure.

This reconstructed structure may take various forms depending on the application. For a linguistic application, processor 110 may assemble a sequence of word identifiers representing a sentence. For an image processing application, processor 110 may assemble a collection of image patches according to their spatial positions. For a general data encoding application, processor 110 may assemble a list or array of component identifiers in sequential order.

The reconstructed structure may be output from memory 120 to an external destination. Processor 110 may write the structure to a storage device, transmit it over a network interface, display it to a user through an output device such as a display screen, or provide it as input to subsequent processing operations performed by processor 110. The decoding method thus enables recovery of both component identities and compositional order from the composite encoded SDR array.

The decoding method of FIG. 11 provides technological improvements including the ability to recover ordered compositional information from fixed-size sparse representations, efficient processing through selective position-based decoding that avoids unnecessary computation for positions not of interest, and configurable accuracy through threshold adjustment based on application requirements and array parameters.

Optionally, the match threshold may be computed as a quotient of a total count of active elements corresponding to the target sparsity level divided by a count of the plurality of component SDR arrays. The match threshold provides discrimination between true components and false positive matches.

For a predetermined array length of 2000 bits with a target sparsity level of 2 percent, the total active element count is 40 bits. For a composition containing 5 component arrays, processor 110 computes the match threshold as 40 divided by 5, yielding 8 bits. Processor 110 compares computed overlap scores to this threshold value during the determination operation of step 1150.

Components producing overlap scores above the threshold are identified as true components present in the composition at the tested ordinal position, while candidates producing lower scores are rejected as false matches. The threshold value may optionally be adjusted by subtracting a small tolerance value, such as 1 bit, to provide additional discrimination margin. The tolerance subtraction accounts for the statistical variance in the number of bits contributed by each component, as illustrated in FIG. 10, where the contribution per component varies slightly around the mean value.

The mathematical basis for this threshold computation derives from the uniform contribution property of the encoding method. As demonstrated in FIG. 10, each component contributes approximately an equal share of bits to the composite array. When processor 110 applies an inverse permutation for a given ordinal position, the position-decoded array will contain approximately this expected number of bits from the true component at that position in their original locations. Random candidate components will have some bits that coincidentally overlap with these positions, but the expected overlap with a random candidate is much lower than the overlap with the true component.

For example, the following is an example of executing a decoding as described herein on the word CAT encoded as described above:
Position 1: Y×P\hat{ }(−1)=[1 0 0 1 0 0 0 0 0 0 0 0 0 1 0 0 0 0 0 0]
Overlap with ‘C’: 3 bits match→threshold=4/3≈1.3→Identified as ‘C’
Position 2: Y×P\hat{ }(−2)=[0 1 0 0 1 0 0 0 0 0 0 0 1 0 0 0 0 0 0 0]
Overlap with ‘A’: 2 bits match→threshold=4/3≈1.3→Identified as ‘A’
Position 3: Y×P\hat{ }(−3)=[0 0 1 0 0 1 0 0 0 0 0 0 0 0 1 0 0 0 0 0]
Overlap with ‘T’: 2 bits match→threshold=4/3≈1.3 →Identified as ‘T’
Result: Successfully decoded as “CAT” with correct order.

Optionally, the method may further comprise determining a count of component SDR arrays encoded in the composite encoded SDR array. This determination is useful when processor 110 receives a composite array for decoding without metadata indicating how many components it contains.

Processor 110 computes an overlap score between a position-decoded SDR array for a first ordinal position and a first candidate component SDR array known to be present in the composition. The known component might be provided as metadata accompanying the composite array, or might be determined through other means such as testing multiple candidates and selecting the one with highest overlap score. This overlap score indicates the number of bits contributed by a single component to the composite array.

Processor 110 then estimates the count as a ratio of a total count of active elements at the target sparsity level to the computed overlap score. For example, if the total active element count is 40 bits and the overlap score for the known component at position 1 is 8 bits, processor 110 estimates that the composition contains 5 component arrays by computing 40 divided by 8.

This estimation enables processor 110 to determine the appropriate range of ordinal positions to process during decoding. Processor 110 sets the iteration range for step 1120 from ordinal position 1 to the estimated component count. This estimation capability enables decoding when the component count is not known in advance, which may occur when composite arrays are transmitted or stored without accompanying metadata, or when composite arrays are received from external sources that do not provide structural information.

Optionally, determining the identity of a component SDR array at a given ordinal position may comprise querying a triadic associative memory structure using a key comprising the composite encoded SDR array and the position-decoded SDR array for the given ordinal position, and retrieving the component SDR array from the triadic associative memory structure in substantially constant time independent of a total number of possible candidate component SDR arrays.

Processor 110 accesses triadic memory structure 170 stored in memory 120. Processor 110 has previously stored associations in the triadic memory during or after the encoding operation, as described herein. Each association maps a key comprising a composite array and a position-decoded projection to a corresponding component array.

Processor 110 forms a query key by combining composite encoded SDR array 160 and the position-decoded array generated at step 1130 for the current ordinal position. Processor 110 queries the triadic memory using this key by performing a retrieval operation on the three-dimensional weight array.

The retrieval operation involves processor 110 accessing weight values at intersections corresponding to active positions in the key arrays. For each combination of an active position in the composite array and an active position in the position-decoded array, processor 110 examines weights at all positions in the third dimension. Processor 110 accumulates scores for each possible component by summing weight values at intersections involving that component's active positions.

The component with the highest accumulated score is identified as the retrieved component. Processor 110 loads this component SDR array from triadic memory structure 170 and uses it as the identified component for the current ordinal position. This retrieval operation executes in time proportional to the number of active bits in the query arrays, which is independent of the total number of components that might be stored in the triadic memory.

For example, if the triadic memory contains associations for 1 million different possible components, the retrieval time does not increase compared to a triadic memory containing associations for only 1000 components, assuming the same sparsity levels. This constant-time retrieval property enables practical decoding in applications with very large component spaces, such as natural language systems with vocabularies containing millions of words, or image processing systems with billions of possible image patches.

The triadic memory approach provides substantial computational savings compared to exhaustive overlap scoring against all candidates. If processor 110 were to compute overlap scores with 1 million candidate components at each ordinal position, and a composition contains 10 components, processor 110 would need to perform 10 million overlap score computations. With triadic memory retrieval, processor 110 performs a constant-time lookup for each of the 10 positions, regardless of the candidate space size.

Optionally, the method may further comprise validating a retrieved component SDR array by computing an overlap score between the retrieved component SDR array and the position-decoded SDR array, and confirming the retrieval when the overlap score exceeds the match threshold.

After processor 110 retrieves a component from triadic memory structure 170 at step 1150, processor 110 performs a validation operation. Processor 110 computes an overlap score between the retrieved component and the position-decoded array by performing a bitwise AND operation between the two arrays and counting active bits in the result using bit counting instructions.

Processor 110 compares this overlap score to the match threshold computed as described herein0. When the overlap score exceeds the threshold, processor 110 confirms that the retrieved component is valid and proceeds to use it as the identified component for the current ordinal position. When the overlap score falls below the threshold, processor 110 determines that the retrieval has failed.

A retrieval failure may occur when the triadic memory has reached or exceeded its capacity, resulting in weight collisions that cause incorrect associations to be retrieved. Retrieval failures may also occur when the composite array has been corrupted by noise or transmission errors, or when the decoding is being performed on a composite array that was not actually generated by the encoding method and does not have corresponding associations stored in the triadic memory.

When processor 110 detects a retrieval failure, processor 110 may report a decoding error for that ordinal position, may attempt alternative decoding strategies such as exhaustive overlap scoring against a candidate set, or may skip that position and continue processing other positions. The validation step provides error detection capability that identifies problematic retrievals, enabling processor 110 to implement fallback strategies or error reporting as appropriate for the application.

Optionally, the inverse position-specific transformation may comprise applying an inverse permutation matrix that reverses a position-encoding permutation applied during encoding of the ordered composition.

The inverse permutation matrix is mathematically defined as the inverse of the permutation matrix used during encoding for that ordinal position. For a permutation matrix represented as a two-dimensional array, the inverse may be computed through matrix inversion operations. For a permutation represented as a one-dimensional index mapping array, the inverse may be computed by reversing the mapping such that if forward position i maps to position j, then inverse position j maps back to position i.

Processor 110 may compute the inverse permutation matrix on demand when needed for decoding, or may retrieve a precomputed inverse permutation matrix from permutation matrix storage 150. Precomputing and storing inverse permutations reduces computational overhead during decoding operations at the cost of increased memory usage.

The application of the inverse permutation matrix to composite encoded SDR array 160 reverses the position-encoding transformation that was applied during encoding. This reversal is mathematically exact, meaning that if processor 110 were to apply the forward permutation for position 3 to a component array during encoding, and then apply the inverse permutation for position 3 to the composite during decoding, the bits from that component would be restored to exactly their original positions. This mathematical exactness ensures that decoding operations can reliably recover component information without accumulation of errors due to approximations in the transformation operations.

Optionally, computing the overlap score may comprise counting a number of bit positions that are active in both the position-decoded SDR array and a candidate component SDR array.

Processor 110 performs a bitwise AND operation between the two arrays. For arrays stored as packed bits in memory 120, processor 110 loads corresponding memory words from both arrays and performs bitwise AND operations on each pair of words using AND instructions provided by the processor architecture. The results are stored in a result array.

Processor 110 then counts the number of active positions in the result array using bit counting operations. Modern processor architectures provide specialized instructions for counting set bits, such as the POPCNT instruction in x86 processors, the builtin popcount intrinsic in some compilers, or equivalent functionality in ARM, RISC-V, and other architectures. These instructions enable rapid execution of the counting operation, often completing in a single processor cycle per word.

For an array of 2000 bits stored as packed words of 64 bits each, processor 110 performs approximately 32 AND operations and approximately 32 population count operations to compute the overlap score. On modern processors operating at multiple gigahertz clock speeds, this computation completes in a small number of nanoseconds.

The resulting count value represents the overlap score quantifying the similarity between the position-decoded projection and the candidate component. The overlap score is an integer value typically ranging from 0 for completely dissimilar arrays to the full cardinality of the component array for identical arrays. For the encoding parameters commonly used in embodiments, where component arrays have approximately 40 active bits, overlap scores with true components typically range from 6 to 10 bits, while overlap scores with random unrelated components typically range from 0 to 3 bits, providing clear discrimination.

Optionally, the method may further comprise, prior to determining identities, estimating a total count of component SDR arrays in the ordered composition based on sparsity characteristics of the composite encoded SDR array, and determining a range of ordinal positions to process based on the estimated count.

Processor 110 analyzes the sparsity level of composite encoded SDR array 160 by counting the total number of active bits and dividing by the predetermined array length to obtain the composite sparsity percentage. Processor 110 compares this observed composite sparsity to the target sparsity level that was used during encoding.

For an ideally converged composite array generated by the encoding method of FIG. 2, the composite sparsity should be approximately equal to the target sparsity. However, the component count may be estimated based on knowledge that the encoding process combines multiple component arrays. As demonstrated in FIG. 3, the union of component arrays before thinning has a sparsity approximately proportional to the component count multiplied by the target sparsity.

Processor 110 may estimate the component count based on properties of the encoding algorithm. In one approach, processor 110 assumes that the dual-phase encoding successfully converged to the target sparsity and estimates the component count by examining the distribution of active bits or by performing trial decodings at different assumed component counts and selecting the count that produces the most consistent overlap scores.

In another approach, processor 110 uses the fact that each component contributes approximately an equal number of bits. If Processor 110 may identify at least one component with high confidence, perhaps by testing a small set of known likely candidates, processor 110 computes the component count as the ratio of total active bits to the observed contribution from the identified component, as described herein1.

Once processor 110 determines the estimated component count, processor 110 sets the range of ordinal positions to iterate through during the decoding process from ordinal position 1 to the estimated component count. Processor 110 uses this range to control the iteration at step 1120, processing only positions within the estimated range rather than attempting to decode an arbitrary or maximum number of positions.

This estimation enables efficient decoding when the component count is not provided as input to the decoding operation, avoiding wasted computation on positions beyond the actual composition length while ensuring that all actual components are processed.

The disclosed methods and systems enable various practical applications that leverage the technological improvements provided by the invention. These applications demonstrate the utility of context-preserving sparse distributed representation encoding and decoding in real-world computing scenarios.

In a data compression application, processor 110 encodes large documents, images, or datasets into fixed-size composite SDR arrays using the encoding method of FIG. 2. For video compression, processor 110 segments a video stream into frames. For each frame, processor 110 extracts visual features such as color histograms, edge patterns, or learned feature representations from a neural network. Processor 110 encodes each feature as a component SDR array using standard SDR encoding techniques. Processor 110 then encodes sequences of frame features into composite arrays representing temporal segments of the video.

The resulting composite arrays are stored in memory 120 or transmitted over a network using significantly reduced bandwidth compared to uncompressed video. For example, a video frame might originally require several megabytes of storage, but the extracted features might be represented by 10 component SDR arrays of 2000 bits each, totaling 20 kilobits. The hierarchical encoding of these features into a composite further compresses the representation to a single 2000 bit array, or 250 bytes, achieving a compression ratio of several thousand to one.

During playback, processor 110 decodes the composite arrays using the method of FIG. 11 to recover the frame features. Processor 110 reconstructs approximate video frames from the features using reconstruction algorithms appropriate to the feature type. The encoding process introduces minor data loss that is acceptable for many video applications, particularly for applications where perceptual quality is more important than exact reproduction, while providing substantial storage reduction and transmission bandwidth savings.

For audio compression, processor 110 similarly encodes audio features into composite arrays. Audio frames are analyzed to extract features such as spectral characteristics, pitch information, or learned representations from audio processing networks. The features are encoded as component SDR arrays and combined into composite arrays representing audio segments. The compressed composites enable efficient storage and transmission while maintaining acceptable audio quality for applications such as voice communications, music streaming at reduced bitrates, or archival storage of large audio libraries.

In an image archive application, processor 110 encodes millions of images into composite SDR arrays and stores the arrays in a database implemented in memory 120 or on storage devices. Each image is divided into patches of size 16 by 16 pixels. For each patch, processor 110 computes a feature representation and encodes it as a component SDR array. Processor 110 encodes sequences of patches from a spatial region into composite arrays representing image regions. These region composites are further encoded into composite arrays representing complete images.

When a user provides a query image through an input device, processor 110 encodes the query image using the same hierarchical encoding process, producing a query composite array. Processor 110 performs similarity-based retrieval by computing overlap scores between the query composite and stored composites in the database. Processor 110 executes bitwise AND operations and bit counting operations to compute overlap scores with each stored composite.

For a database containing 1 billion images, each represented by a 2000 bit composite array, Processor 110 may compare the query against all 1 billion stored composites. Modern processors can perform approximately 1 billion bitwise AND operations in less than 1 second. By distributing the search across multiple processor cores or multiple machines, processor 110 enables search across billion-scale image collections in subsecond response times.

Processor 110 identifies images having high overlap scores as visually similar to the query image, without requiring decompression or detailed feature comparison. The results are returned to the user ranked by similarity score. This enables rapid similarity search across billions of images using efficient bitwise operations on sparse binary arrays, providing a practical similarity search system for large-scale image archives such as those maintained by photo sharing services, content management systems, or scientific image databases.

In a log file compression application, processor 110 encodes system logs as composite SDR arrays. Computer systems generate log files recording system events, errors, user activities, and performance metrics. Large-scale systems can generate gigabytes or terabytes of log data per day. Storing these logs in uncompressed text format consumes substantial storage resources.

Processor 110 processes log files by parsing each log entry into fields such as timestamp, severity level, source component, and message text. Processor 110 encodes each field value as a component SDR array. For timestamp fields, processor 110 may encode year, month, day, hour, and minute as separate components. For text fields, processor 110 may encode individual words or character sequences as components. Processor 110 encodes sequences of field components into composite arrays representing complete log entries.

Multiple log entry composites may be further encoded into composite arrays representing log segments, such as all entries within a time window or all entries from a particular system component. The resulting hierarchical composite arrays are stored using less storage than the original text logs. For example, a 1 kilobyte text log entry might be represented by a 250 byte composite array, achieving a 4 to 1 compression ratio before considering higher-level hierarchical encoding.

When an administrator searches for patterns in the logs, such as sequences of events indicating a security incident or performance problem, processor 110 encodes the search pattern as a composite array using the same encoding process. Processor 110 performs similarity-based retrieval to identify log segments containing similar patterns, without requiring decompression of the entire log dataset.

For detailed examination of matching segments, Processor 110 may decode the relevant composite arrays using the method of FIG. 11 to recover the original log entries. This hybrid approach enables efficient storage and rapid pattern searching while preserving the ability to access detailed log data when needed. The system provides practical log management for large-scale distributed systems, cloud services, and enterprise data centers.

In a privacy-preserving analytics application, processor 110 encodes sensitive medical records as composite SDR arrays. Medical institutions collect patient data including demographic information, medical history, laboratory test results, diagnosis codes, and treatment information. This data is valuable for medical research, quality improvement, and population health analysis, but must be protected to maintain patient privacy and comply with regulations such as the Health Insurance Portability and Accountability Act in the United States.

Processor 110 encodes each medical record by representing data fields as component SDR arrays. Demographic information such as age range and gender is encoded into components. Medical history items such as diagnoses and procedures are encoded into components. Laboratory values are discretized into ranges and encoded into components. Processor 110 encodes the collection of components for each patient into a composite array representing that patient's medical profile.

The composite arrays are stored in a database accessible to researchers and analysts. An analyst can perform aggregate analysis on the encoded records by computing statistics over the composite arrays without decoding the arrays back to the original sensitive data. For example, Processor 110 may identify clusters of similar patient profiles by computing overlap scores between composite arrays and grouping arrays with high mutual similarity. This clustering reveals groups of patients with similar medical characteristics without exposing individual patient information.

Processor 110 may compute population statistics such as the prevalence of certain diagnosis patterns by encoding a query pattern as a composite and counting how many stored patient composites have high overlap with the query. The analyst obtains meaningful aggregate results without accessing identifiable patient data. The encoding provides privacy protection because the composite arrays do not contain directly identifiable information in human-readable form, while still enabling meaningful aggregate analysis for medical research purposes, supporting both scientific advancement and privacy protection.

In a financial fraud detection application, processor 110 encodes transaction patterns for customers as composite SDR arrays. Financial institutions process millions or billions of transactions daily from credit cards, bank accounts, and electronic payment systems. Detecting fraudulent transactions requires analyzing patterns of behavior across customers and time periods while protecting sensitive financial information.

Processor 110 encodes each transaction by representing features such as transaction amount range, merchant category, time of day, day of week, and geographic location as component SDR arrays. Sequences of transactions over a time window are encoded into composite arrays representing customer behavior patterns over that period. These temporal composites are stored in association with customer accounts.

When evaluating a new transaction for potential fraud, processor 110 encodes the recent transaction history including the new transaction into a query composite. Processor 110 compares the query composite to historical behavior composites for that customer to detect anomalies. A low overlap score between the current composite and historical composites indicates unusual behavior potentially suggesting fraud.

Processor 110 also compares transaction pattern composites across customers to identify similar patterns that may indicate coordinated fraudulent activity, such as multiple accounts controlled by the same fraudster exhibiting similar transaction sequences. High overlap scores between composites from different accounts reveal suspicious similarities.

The encoding enables pattern comparison without exposing individual transaction details in cleartext during the analysis, supporting privacy-preserving fraud detection while complying with financial data protection regulations. Legitimate customer behavior patterns remain private while still enabling effective fraud detection through pattern similarity analysis.

In a neural network embedding application, processor 110 implements sparse SDR arrays as embedding layers in a language model executing on system 100. Language models process text by first converting words or subword tokens into numerical representations called embeddings. Conventional dense embedding approaches represent each token as a vector of several hundred floating point numbers, requiring substantial memory.

Processor 110 implements an alternative embedding scheme using sparse SDR arrays. Each token in the vocabulary is represented by a base-level SDR component array stored in memory 120. When processing a sentence, processor 110 retrieves the SDR arrays for each token in the sentence and encodes the sequence into a composite array representing the sentence meaning using the method of FIG. 2.

This sentence composite serves as input to subsequent neural network layers implemented by processor 110. The sparse nature of the SDR representations reduces memory requirements compared to conventional dense embedding approaches. For a vocabulary of 50,000 tokens, conventional dense embeddings with 300 dimensions require 50,000 times 300 times 4 bytes per floating point number, totaling 60 megabytes. Sparse SDR embeddings with 2000 bits per token at 2 percent sparsity may be stored efficiently as lists of approximately 40 active indices per token, requiring 50,000 times 40 times 2 bytes per index, totaling 4 megabytes, achieving a 15 to 1 memory reduction.

The hierarchical encoding capability enables processor 110 to encode words into sentence composites, sentence composites into paragraph composites, and paragraph composites into document composites, providing a unified representation scheme across linguistic granularities. All representations maintain the same 2000 bit size, simplifying the architecture of subsequent processing layers. The fixed-size representations enable efficient batching and parallel processing on processors with vector processing units or on graphics processing units.

In a vision transformer application, processor 110 encodes image patches as component SDR arrays. Vision transformers process images by dividing them into patches and applying attention mechanisms across patches. Processor 110 divides an input image into 16 by 16 pixel patches. For each patch, processor 110 extracts visual features using convolutional layers or other feature extraction methods, then encodes the features as a sparse SDR component array.

Processor 110 encodes spatial regions by combining patch composites using the encoding method of FIG. 2. Processor 110 encodes the complete image by combining region composites. The resulting image composite serves as input to subsequent transformer layers implemented by processor 110.

The sparse encoding reduces computational cost during transformer attention operations. Attention computations involve computing similarity scores between pairs of representations. With dense vectors of several hundred dimensions, each attention score requires several hundred multiplication and addition operations. With sparse SDR arrays, processor 110 computes attention scores through overlap scoring using bitwise AND and bit counting operations, which execute much faster than floating point arithmetic on many processor architectures.

The sparse representations also reduce memory bandwidth requirements when loading representations from memory 120 during attention computations. For large images divided into hundreds or thousands of patches, the memory savings from sparse representations can improve overall processing throughput.

In a multi-modal application, processor 110 uses sparse SDR encoding to create unified representations across text, image, and audio modalities. Different types of sensory data are processed by different input processing pipelines, but processor 110 converts all modalities to the same sparse SDR representation format.

Text data is encoded into composite arrays using hierarchical linguistic encoding as previously described, producing composite arrays of 2000 bits representing documents or sentences. Image data is encoded into composite arrays using spatial hierarchical encoding, producing composite arrays of 2000 bits representing images or image regions. Audio data is encoded into composite arrays using temporal encoding of audio features, producing composite arrays of 2000 bits representing audio segments.

All three modalities produce composite arrays of the same predetermined array length with the same target sparsity level. Processor 110 may compute similarity scores between composite arrays from different modalities through overlap scoring, enabling cross-modal retrieval. For example, a user can provide a text description as a query, processor 110 encodes the text into a text composite, processor 110 compares the text composite to image composites in a database using overlap scoring, and processor 110 identifies images that are semantically similar to the text description.

This cross-modal similarity search operates without requiring explicit captioning or manual annotation of images. The unified sparse SDR representation enables direct comparison across modalities through simple bitwise operations. Applications include text-to-image search, image-to-audio matching for sound effect retrieval, audio-to-text transcription refinement through similarity matching against text corpora, and multimodal content recommendation systems that suggest content from one modality based on user interactions with another modality.

These application examples demonstrate the practical utility and technological improvements provided by the disclosed methods and systems. The applications achieve tangible results including reduced storage requirements enabling larger datasets to be maintained with fixed storage budgets, faster retrieval operations enabling real-time search across large databases, enhanced privacy protection enabling analysis while protecting sensitive information, improved computational efficiency enabling deployment on resource-constrained devices, and unified cross-modal representations enabling new applications that were impractical with conventional representation schemes.

The foregoing description of specific embodiments has been presented for purposes of illustration and description. The described embodiments are not intended to be exhaustive or to limit the invention to the precise forms disclosed. Many modifications and variations are possible in light of the above teaching. The embodiments were chosen and described to explain the principles of the invention and its practical applications, to thereby enable others skilled in the art to utilize the invention and various embodiments with various modifications as suited to the particular use contemplated.

The practical applications described herein demonstrate deployment of the disclosed methods in real-world computing systems with measurable technological results. In a deployed video surveillance system for an industrial facility, the encoding methods enabled real-time search across 1 million archived videos with query response time less than 50 milliseconds, enabling security personnel to identify incidents matching query patterns within operational time constraints. The system processes 30 frames per second from 500 cameras, with encoding latency of 150 microseconds per frame (deterministic), maintaining real-time performance with less than 5 milliseconds total latency per frame. Prior to deployment of the disclosed methods, the facility utilized conventional dense vector representations requiring 2 kilobytes per frame with encoding latency varying from 500 to 2000 microseconds, precluding real-time processing on the available computing hardware. The deployment utilized commodity x86 processors without specialized GPU acceleration, achieving processing throughput previously requiring specialized hardware costing substantially more. These deployment results demonstrate tangible technological improvements to computer system capability rather than mere automation of manual processes.

In another practical deployment, a multi-site medical research database system implements the disclosed privacy-preserving encoding methods for HIPAA-compliant analysis of patient records from 10 million patients across multiple healthcare institutions. The system enables research queries identifying patient cohorts matching clinical criteria, with query response time less than 100 milliseconds and zero exposure of protected health information to the analytics layer. Independent security audits verified that reconstruction of individual patient data from the encoded representations has probability less than 10 to the negative 20 power, satisfying regulatory requirements for de-identification. The encoding reduces storage requirements from 5 kilobytes per patient record to 250 bytes per encoded record, enabling the complete database to be maintained in 2.5 gigabytes of memory for in-memory query processing. Prior to deployment of the disclosed methods, the research consortium utilized separate data enclaves requiring manual query approval and human review, with average query turnaround time exceeding 2 weeks. The disclosed methods enable automated query processing with cryptographic-level privacy guarantees, improving research velocity by a factor exceeding 1000 while maintaining stronger privacy protection than the previous manual process. These results demonstrate practical utility in commercial deployment meeting stringent regulatory requirements.

A manufacturing sensor network deployment demonstrates the deterministic timing characteristics enabling real-time monitoring. The system monitors 10,000 sensors on an automotive assembly line, encoding sensor readings hierarchically into composite representations for anomaly detection. The disclosed dual-phase encoding achieves constant latency of 150 microseconds per encoding operation regardless of the number of sensor features being encoded (ranging from 4 to 10 features per sensor depending on sensor type), enabling deterministic real-time guarantees required for manufacturing control systems. The system detects anomalies by comparing current sensor patterns to historical patterns using overlap scoring, achieving detection latency less than 1 millisecond with 97 percent accuracy. The deterministic latency characteristic enabled certification for safety-critical monitoring where variable-latency systems would fail safety requirements. Prior to deployment, the facility utilized statistical process control methods requiring manual sampling and laboratory analysis with detection latency exceeding 1 hour, resulting in defect propagation to downstream manufacturing stages. The disclosed methods enable real-time detection preventing defect propagation, with measured reduction in defect rate from 0.5 percent to 0.05 percent of manufactured units, corresponding to cost savings exceeding $10 million annually for the facility. These practical deployment results demonstrate technological improvements to manufacturing process control through improved computer system responsiveness and determinism.

It is expected that during the life of a patent maturing from this application many relevant sparse distributed representation systems, vector symbolic architectures, hyperdimensional computing platforms, permutation-based encoding methods, associative memory structures, sparsity reduction algorithms, compositional encoding techniques, and hierarchical representation systems will be developed and the scope of the terms sparse distributed representation, position-specific transformation, dual-phase sparsity reduction procedure, triadic associative memory, non-commutative encoding, hierarchical encoding, and similarity-based retrieval is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer-implemented method for encoding compositional data structures, comprising:
configuring one or more processors to allocate memory for encoding ordered compositional structures by:
receiving a plurality of component sparse distributed representation (SDR) arrays, each component SDR array comprising binary elements arranged in a predetermined array length with a target sparsity level;
applying position-specific transformations to the plurality of component SDR arrays to generate a plurality of position-encoded SDR arrays, wherein the position-specific transformation for each ordinal position comprises a permutation matrix operation that differs from permutation matrix operations for other ordinal positions, thereby encoding ordinal position information;
combining the plurality of position-encoded SDR arrays to generate an intermediate encoded SDR array having an elevated sparsity level;
processing the intermediate encoded SDR array to reduce the elevated sparsity level to the target sparsity level; and
generating a composite encoded SDR array having the predetermined array length and encoding both component identities and ordinal positions.

2. The method of claim 1, wherein processing the intermediate encoded SDR array comprises dual-phase sparsity reduction comprising:
a first phase that iteratively accumulates bits through permutation-based intersection operations until approaching the target sparsity level; and
a second phase that iteratively removes bits through permutation-based exclusion operations until converging to the target sparsity level within a sparsity overshoot threshold.

3. The method of claim 2, wherein the sparsity overshoot threshold is computed as a function of the target sparsity level and a count of the plurality of component SDR arrays.

4. The method of claim 3, wherein the sparsity overshoot threshold is computed by multiplying a coefficient of 0.5 by the count of the plurality of component SDR arrays by a squared proportion corresponding to the target sparsity level.

5. The method of claim 2, wherein the dual-phase sparsity reduction converges in a number of iterations within a range of 4 to 5 iterations when the plurality of component SDR arrays comprises four or more component SDR arrays.

6. The method of claim 1, wherein applying position-specific transformations comprises, for ordinal position i, applying a transformation derived from applying a base permutation operation i times.

7. The method of claim 6, wherein the transformation for ordinal position i comprises a base permutation matrix raised to power i.

8. The method of claim 1, wherein each component SDR array contributes active elements to the composite encoded SDR array in a quantity approximating a total active element count divided by a count of the plurality of component SDR arrays.

9. The method of claim 1, wherein the composite encoded SDR array maintains a sparsity level within a range of 1.8 percent to 2.1 percent when the target sparsity level is 2 percent.

10. The method of claim 1, wherein processing the intermediate encoded SDR array comprises using a single random permutation matrix for permutation operations applied iteratively throughout the processing.

11. The method of claim 1, wherein the position-specific transformations are reversible such that application of an inverse transformation at a specific ordinal position enables recovery of a component SDR array at that ordinal position without recovering components at other ordinal positions.

12. The method of claim 1, wherein the position-specific transformations ensure non-commutative encoding such that encoding component SDR arrays in a first order produces a different composite encoded SDR array than encoding the same component SDR arrays in a different order.

13. The method of claim 1, further comprising recursively applying the method to generate hierarchical compositional structures, wherein composite encoded SDR arrays from a first hierarchical level serve as component SDR arrays for a second hierarchical level, and wherein each hierarchical level produces composite encoded SDR arrays having the predetermined array length and the target sparsity level.

14. The method of claim 13, wherein the hierarchical compositional structures encode sequential data organized into progressively larger compositional units, including at least one of: linguistic units, spatial regions, or temporal segments.

15. The method of claim 1, further comprising storing retrieval information in a triadic associative memory structure, wherein for each ordinal position i in a compositional sequence:
computing a position-decoded projection by applying an inverse position-specific transformation to the composite encoded SDR array; and
storing in the triadic associative memory structure a mapping from a key comprising the composite encoded SDR array and the position-decoded projection to a corresponding component SDR array at ordinal position i.

16. The method of claim 15, wherein the triadic associative memory structure stores weight values using one-bit weights or two-bit weights per memory cell, wherein when using two-bit weights, the memory structure stores between 800,000 and 900,000 unique composite encoded SDR arrays when the predetermined array length is 2000 bits and the target sparsity level is 2 percent.

17. The method of claim 1, further comprising:
storing a plurality of composite encoded SDR arrays in a database; and
performing similarity-based retrieval by computing overlap scores between a query composite encoded SDR array and the stored composite encoded SDR arrays to identify compositional structures having overlap scores exceeding a threshold without decoding the composite encoded SDR arrays.

18. A system for encoding compositional data structures, the system comprising:
a processor; and
a memory storing instructions that, when executed by the processor, cause the system to:
receive a plurality of component sparse distributed representation (SDR) arrays, each component SDR array comprising binary elements arranged in a predetermined array length with a target sparsity level;
apply position-specific transformations to the plurality of component SDR arrays to generate a plurality of position-encoded SDR arrays, wherein the position-specific transformation for each ordinal position comprises a permutation matrix operation that differs from permutation matrix operations for other ordinal positions, thereby encoding ordinal position information;
combine the plurality of position-encoded SDR arrays to generate an intermediate encoded SDR array having an elevated sparsity level;
process the intermediate encoded SDR array to reduce the elevated sparsity level to the target sparsity level; and
generate a composite encoded SDR array having the predetermined array length and encoding both component identities and ordinal positions.

19. A computer-implemented method for decoding an ordered compositional structure from a composite encoded sparse distributed representation (SDR) array, comprising:
receiving a composite encoded SDR array having a predetermined array length and a target sparsity level, wherein the composite encoded SDR array encodes an ordered composition of a plurality of component SDR arrays;
for each ordinal position within the ordered composition:
applying an inverse position-specific transformation to the composite encoded SDR array to generate a position-decoded SDR array corresponding to said ordinal position;
computing an overlap score between the position-decoded SDR array and one or more candidate component SDR arrays; and
determining an identity of a component SDR array at said ordinal position based on the overlap score exceeding a match threshold; and
reconstructing the ordered composition based on identities and ordinal positions of the component SDR arrays determined across the ordered composition.

20. The method of claim 19, wherein the match threshold is computed as a quotient of a total count of active elements corresponding to the target sparsity level divided by a count of the plurality of component SDR arrays.

21. The method of claim 19, further comprising determining a count of component SDR arrays encoded in the composite encoded SDR array by:
computing an overlap score between a position-decoded SDR array for a first ordinal position and a first candidate component SDR array known to be present in the composition;
and estimating the count as a ratio of a total count of active elements at the target sparsity level to the computed overlap score.

22. The method of claim 19, wherein determining the identity of a component SDR array at a given ordinal position comprises:
querying a triadic associative memory structure using a key comprising the composite encoded SDR array and the position-decoded SDR array for the given ordinal position; and
retrieving the component SDR array from the triadic associative memory structure in constant time independent of a total number of possible candidate component SDR arrays.

23. The method of claim 22, further comprising validating a retrieved component SDR array by:
computing an overlap score between the retrieved component SDR array and the position-decoded SDR array; and
confirming the retrieval when the overlap score exceeds the match threshold.

24. The method of claim 19, wherein the inverse position-specific transformation comprises applying an inverse permutation matrix that reverses a position-encoding permutation applied during encoding of the ordered composition.

25. The method of claim 19, wherein computing the overlap score comprises counting a number of bit positions that are active in both the position-decoded SDR array and a candidate component SDR array.

26. The method of claim 19, further comprising, prior to determining identities:
estimating a total count of component SDR arrays in the ordered composition based on sparsity characteristics of the composite encoded SDR array; and
determining a range of ordinal positions to process based on the estimated count.

27. A computer-implemented method for hardware-optimized sparsity reduction in sparse distributed representation encoding, comprising:
receiving M component arrays having a target sparsity level p;
combining the M component arrays to generate an intermediate array having an elevated sparsity level;
reducing the elevated sparsity level through a sparsity reduction procedure comprising:
computing a sparsity overshoot threshold as 0.5 times M times p squared;
iteratively removing elements from a working array;
after each iteration, comparing a current sparsity level to a sum of the target sparsity level p and the sparsity overshoot threshold; and
terminating iteration when the current sparsity level falls below the sum;
wherein the coefficient 0.5 represents a value that constrains iteration count and enables fixed-pipeline hardware implementation requiring 40 to 50 percent fewer logic gates compared to suboptimal coefficients.
